(19) United States
(12) Patent Application Publication
(10) Pub. No.: US 2019/0096002 A1
(43) Pub. Date: Mar. 28, 2019

(54) Systems and Methods for Cross-border Health Insurance

(71) Applicant: GLOBEMED LIMITED, Sin El Fil (LB)

(72) Inventors: Mounir Michel Kharma, Horsh Tabet (LB); Jad Geries Moawad, Naccache (LB); Rabih Maurice KHARMA, Zouk Mikael (LB)

(21) Appl. No.: 16/199,008

(22) Filed: Nov. 23, 2018

Related U.S. Application Data
(63) Continuation-in-part of application No. 13/837,497, filed on Mar. 15, 2013, now abandoned.

(51) Int. Cl. G06Q 40/08

(52) U.S. Cl. CPC G06Q 40/08

(57) ABSTRACT

A system and method for guarantor computing system to provide cross-border healthcare services to an adherent. The guarantor computing system may be configured to receive an eligibility request from a first computing system, determine that the policy is associated with a different territory/location, determine a disease-related condition (DRC), generate and send a proxy eligibility request and the DRC to a second computing system in a second territory/location, receive a proxy healthcare approval confirmation message from the second computing system, and generate a healthcare approval message based on a combination of the information included in the proxy healthcare approval confirmation message, the information included in the service eligibility request, and information stored in a memory coupled to the computing system. The computing system may send the generated healthcare approval message to the first computing system to cause the first computing system to approve the provision of the healthcare service.

### RELATED APPLICATIONS

This application is a continuation in part of U.S. patent application Ser. No. 13/837,497, entitled “Systems and Methods for Cross-border Health Insurance” filed Mar. 15, 2013, the entire contents of which are hereby incorporated by reference for all purposes.

### BACKGROUND

Though different in many respects from other types of services, healthcare services and healthcare insurance services are also impacted by globalization. For example, some countries, especially developing ones, can attract customers/patients from other countries by offering high quality healthcare at a lower cost than is available in their home country. In contrast, according to an estimate, the cost of health insurance in the U.S.A. rose between 8.2% and 13.9% per year from 2000 to 2005. Some reports have indicated that rises in healthcare costs in the U.S.A. have outpaced rises in wages. Treatments offered in western Europeans countries attract infertile couples from the United States because they often cost half or one third of those provided in North America. Additionally, elective surgery offered in highly sophisticated Indian hospitals tends to cost only 10-20% of identical treatment in western countries. Thus, it is believed that citizens of the United States and other developed nations are now traveling to other countries in order to save on the costs of healthcare.

In addition, globalization in general has also increased the numbers of business travelers who head outside their home country for work on a regular basis. These business travelers, whether in another country for a short or extended period of time, will likely end up seeking healthcare services at some point. Further, recreational travelers also experience the need for healthcare services from time to time as well.

By traveling to other countries, it is often unclear to an individual how their healthcare insurance effects payment for services in a country different from their home country. In many cases, the legal, regulatory and/or tax schemes or structures in other countries are much different from a home country. Furthermore, there may be transactional barriers to payment, including issues dealing with language differences and/or currency exchanges.

Thus, there is a need for a system and method that allows for easily and efficient handling of claims for healthcare insurance services for healthcare services that are provided outside of a beneficiary's home country or territory.

The present disclosure is directed toward overcoming one or more of the above-identified problems.

### SUMMARY

The various aspects include methods of providing or approving healthcare services requested by an adherent, which may include receiving, via a processor in a healthcare guarantor computing system, a service eligibility request from a first computing system in a first location (in which the service eligibility request identifies the adherent, a proxy guarantor, a policy, a healthcare service, and a disease code of a first disease code system), determining via the processor in the healthcare guarantor computing system a disease-related condition associated with the disease code, determining via the processor in the healthcare guarantor computing system whether the policy is associated with a second location, determining via the processor in the healthcare guarantor computing system whether the second location uses a different disease code system than the first disease code system in response to determining that the policy is associated with the second location, generating via the processor in the healthcare guarantor computing system a proxy service eligibility request based on the received service eligibility request in response to determining that the policy is associated with the second location (in which the proxy service eligibility request replaces an identifier of a healthcare provider with an identifier of a proxy provider), sending via the processor in the healthcare guarantor computing system the proxy service eligibility request and the determined disease-related condition to a second computing system in the second location, receiving via the processor in the healthcare guarantor computing system a proxy healthcare approval confirmation message in response to sending the proxy service eligibility request to the second computing system in the second location, generating via the processor in the healthcare guarantor computing system a healthcare approval message based on a combination of information included in the proxy healthcare approval confirmation message received from the second computing system, the information included in the service eligibility request received from the first computing system, and information stored in a memory coupled to the healthcare guarantor computing system, and sending the generated healthcare approval message to the first computing system to enable the first computing system to provide the healthcare service to the adherent.

In an aspect, the method may include receiving, via a processor in the second computing system, the proxy service eligibility request and the determined disease-related condition from the healthcare guarantor computing system, replacing the identifier of a proxy guarantor with an identifier of an actual guarantor, using information included in the received proxy service eligibility request to determine whether the policy is valid, using the received disease-related condition information to determine whether the adherent is eligible to receive the healthcare service in response to determining that the policy is valid, generating the proxy healthcare approval confirmation message to include information indicating whether the adherent is eligible to receive all or part of the healthcare service, in which the generated proxy healthcare approval confirmation message replaces the identifier of the actual guarantor with the identifier of the proxy guarantor, and sending the generated proxy healthcare approval confirmation message to the healthcare guarantor computing system.

In a further aspect, the method may include determining, via the processor in the second computing system, based on information included in the received proxy service eligibility request that the healthcare provider is a proxy provider, generating healthcare provider specific control information and determining costs associated with the healthcare service in response to determining that the healthcare provider is not a proxy provider, and determining to forgo generating healthcare provider specific control information and determining the costs associated with the healthcare service in response to determining that the healthcare provider is a proxy provider.

In a further aspect, the method may include determining, via the processor in the healthcare guarantor computing system, based on information included in the received service eligibility request is for a proxy guarantor, and determining to forgo determining whether the policy is valid and whether the adherent is eligible to receive all or part of the healthcare service in response to determining that the received service eligibility request is for the proxy guarantor. In a further aspect, the method may include determining, via the processor in the healthcare guarantor computing system, based on information included in the received service eligibility request is for a proxy guarantor, in which the operation of generating the proxy service eligibility request is performed in response to determining that the received service eligibility request is for the proxy guarantor. In a further aspect, the method may include determining, via the processor in the healthcare guarantor computing system, based on information included in the received service eligibility request is for a proxy guarantor, and determining to forgo using mappings in response to determining that the received service eligibility request is for the proxy guarantor.

In a further aspect, the method may include determining, via the processor in the healthcare guarantor computing system, based on information included in the received service eligibility request is for a proxy guarantor, determining that the second computing system is a computing system within a plurality of available computing systems that is responsible for receiving requests for the proxy guarantor, in which the operation of sending the proxy service eligibility request and the determined disease-related condition to the second computing system in the second location is performed in response that determining that the second computing system is the computing system responsible for receiving requests for the proxy guarantor.

In an aspect, sending the proxy service eligibility request and the determined disease-related condition to the second computing system in the second location includes sending the proxy service eligibility request and the determined disease-related condition from a first healthcare guarantor computing system associated with a first healthcare guarantor in a first country to a different healthcare guarantor computing system associated with a different healthcare guarantor in a different country that uses a different disease code system than the first disease code system.

Further aspects include a computing device that includes a processor configured with processor-executable instructions to perform operations that may include receiving a service eligibility request from a first computing system in a first location, in which the service eligibility request identifies an adherent, a proxy guarantor, a policy, a healthcare service, and a disease code of a first disease code system, determining a disease-related condition associated with the disease code, determining whether the policy is associated with a second location, determining whether the second location uses a different disease code system than the first disease code system in response to determining that the policy is associated with the second location, generating a proxy service eligibility request based on the received service eligibility request in response to determining that the policy is associated with the second location, in which the proxy service eligibility request replaces an identifier of a healthcare provider with an identifier of a proxy provider, sending the proxy service eligibility request and the determined disease-related condition to a second computing system in the second location, receiving a proxy healthcare approval confirmation message in response to sending the proxy service eligibility request to the second computing system in the second location, generating a healthcare approval message based on a combination of information included in the proxy healthcare approval confirmation message received from the second computing system, information included in the service eligibility request received from the first computing system, and information stored in memory, and sending the generated healthcare approval message to the first computing system to enable the first computing system to provide the healthcare service to the adherent.

In an aspect, the processor may be configured with processor-executable software instructions to perform operations further including determining based on information included in the received service eligibility request is for a proxy guarantor, and determining to forgo determining whether the policy is valid and whether the adherent is eligible to receive all or part of the healthcare service in response to determining that the received service eligibility request is for the proxy guarantor. In a further aspect, the processor may be configured with processor-executable software instructions to perform operations further including determining based on information included in the received service eligibility request is for a proxy guarantor, in which the operation of generating the proxy service eligibility request is performed in response to determining that the received service eligibility request is for the proxy guarantor.

In a further aspect, the processor may be configured with processor-executable software instructions to perform operations further including determining based on information included in the received service eligibility request is for a proxy guarantor, and determining to forgo using mappings in response to determining that the received service eligibility request is for the proxy guarantor. In a further aspect, the processor may be configured with processor-executable software instructions to perform operations further including determining based on information included in the received service eligibility request is for a proxy guarantor, determining that the second computing system is a computing system within a plurality of available computing systems that is responsible for receiving requests for the proxy guarantor, in which the operation of sending the proxy service eligibility request and the determined disease-related condition to the second computing system in the second location is performed in response that determining that the second computing system is the computing system responsible for receiving requests for the proxy guarantor.

In a further aspect, the processor may be configured with processor-executable software instructions to perform operations such that sending the proxy service eligibility request and the determined disease-related condition to the second computing system in the second location includes sending the proxy service eligibility request and the determined disease-related condition from a first healthcare guarantor computing system associated with a first healthcare guarantor in a first country to a different healthcare guarantor computing system associated with a different healthcare guarantor in a different country that uses a different disease code system than the first disease code system.

Further aspects include a non-transitory server-readable storage medium having stored thereon processor-executable instructions configured cause a computing device to perform operations that may include receiving a service eligibility request from a first computing system in a first location, in which the service eligibility request identifies an adherent, a proxy guarantor, a policy, a healthcare service, and a disease code of a first disease code system, determining a disease-related condition associated with the disease code, determining whether the policy is associated with a second location, determining whether the second location uses a different disease code system than the first disease code system in response to determining that the policy is associated with the second location, generating a proxy service eligibility request based on the received service eligibility request in response to determining that the policy is associated with the second location, in which the proxy service eligibility request replaces an identifier of a healthcare provider with an identifier of a proxy provider, sending the proxy service eligibility request and the determined disease-related condition to a second computing system in the second location, receiving a proxy healthcare approval confirmation message in response to sending the proxy service eligibility request to the second computing system in the second location, generating a healthcare approval message based on a combination of information included in the proxy healthcare approval confirmation message received from the second computing system, information included in the service eligibility request received from the first computing system, and information stored in a memory coupled to the computing device, and sending the generated healthcare approval message to the first computing system to enable the first computing system to provide the healthcare service to the adherent.

In an aspect, the stored processor-executable instructions may be configured to cause a processor to perform operations further including determining based on information included in the received service eligibility request is for a proxy guarantor, and determining to forgo determining whether the policy is valid and whether the adherent is eligible to receive all or part of the healthcare service in response to determining that the received service eligibility request is for the proxy guarantor. In a further aspect, the stored processor-executable instructions may be configured to cause a processor to perform operations further including determining based on information included in the received service eligibility request is for a proxy guarantor, in which the stored processor-executable instructions may be configured to cause a processor to perform operations such that the operation of generating the proxy service eligibility request is performed in response to determining that the received service eligibility request is for the proxy guarantor. In a further aspect, the stored processor-executable instructions may be configured to cause a processor to perform operations further including determining based on information included in the received service eligibility request is for a proxy guarantor, and determining to forgo using mappings in response to determining that the received service eligibility request is for the proxy guarantor.

In a further aspect, the stored processor-executable instructions may be configured to cause a processor to perform operations further including determining based on information included in the received service eligibility request is for a proxy guarantor, determining that the second computing system is a computing system within a plurality of available computing systems that is responsible for receiving requests for the proxy guarantor, in which the stored processor-executable instructions may be configured to cause a processor to perform operations such that the operation of sending the proxy service eligibility request and the determined disease-related condition to the second computing system in the second location is performed in response that determining that the second computing system is the computing system responsible for receiving requests for the proxy guarantor.

In a further aspect, the stored processor-executable instructions may be configured to cause a processor to perform operations such that sending the proxy service eligibility request and the determined disease-related condition to the second computing system in the second location includes sending the proxy service eligibility request and the determined disease-related condition from a first healthcare guarantor computing system associated with a first healthcare guarantor in a first country to a different healthcare guarantor computing system associated with a different healthcare guarantor in a different country that uses a different disease code system than the first disease code system.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 depicts a flowchart for a member enrollment procedure of the present disclosure.

FIG. 2 depicts a flowchart for an adherent eligibility determination procedure of the present disclosure.

FIG. 3 depicts a flowchart for a claim processing adjudication procedure of the present disclosure.

FIG. 4 depicts a flowchart for a claim closing procedure of the present disclosure.

FIGS. 5A-B illustrate network architecture for various embodiments of the present disclosure.

FIG. 6 depicts an exemplary computer system in which embodiments of the present disclosure may be implemented.

FIGS. 7-10 are process flow diagrams illustrating methods of providing or approving healthcare services requested by an adherent in accordance with the various embodiments.

FIG. 11 is a component diagram of an example server suitable for implementing the various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The present disclosure allows members of a healthcare network of a healthcare insurer to benefit from healthcare services wherever they may be traveling in countries where the healthcare network is present.

### Definitions

The term “adherent” is used herein to mean a member or beneficiary of a healthcare insurance network provided by a healthcare insurance provider or healthcare insurer.

The term “healthcare provider” is used herein to mean an individual or an institution that provides preventive, curative, promotional, and/or rehabilitative healthcare services in a systematic way to individuals, families or communities. This may include hospitals, clinics, primary care centers, and other service delivery points.

The terms “healthcare guarantor” and “healthcare payer” may be used interchangeably herein to refer to an entity or institution that provides healthcare insurance coverage to an adherent. Examples of healthcare payer institutions include United Health Group, Aetna, Anthem, Humana, and Cigna.

The term “healthcare services” is used herein to mean the diagnosis, treatment, and/or prevention of disease, illness, injury, and/or other physical and mental impairments in humans and other animals. Healthcare services are delivered by practitioners in medicine, chiropractic, dentistry, optometry, nursing, pharmacy, allied health, and/or by other care providers. These services may include, as a very small set of possible examples: a prescription for medicine, general physician services, an elective or necessary surgical procedure, emergency treatment, etc.

The term “coverage amount” is used herein to mean a financial payment that is made, or is to be made, by a healthcare insurance provider to a healthcare provider on behalf of a beneficiary and may include a predetermined coverage amount for particular healthcare services.

The Centers for Medicare and Medicaid Services (CMS) and the National Center for Health Statistics (NCHS), two departments within the U.S. Federal Government's Department of Health and Human Services (DHHS), provide guidelines for coding and reporting via the International Classification of Diseases, 10th Revision, Clinical Modification (ICD-10-CM). As such, the term “ICD-10-CM” is used herein to refer to the system used by physicians and other healthcare providers to classify and code all diagnoses, symptoms and procedures recorded in conjunction with hospital care in the United States. The term “ICD-10-AU” is used herein to refer to a similar (but different) system used in Australia to code diagnoses, symptoms and procedures. It should be understood that there are many different ICD and disease coding systems used throughout the world, and nothing in this application should be use to limit the claims to “ICD-10-CM” or “ICD-10-AU” unless expressly recited as such in the claims.

### Enrollment

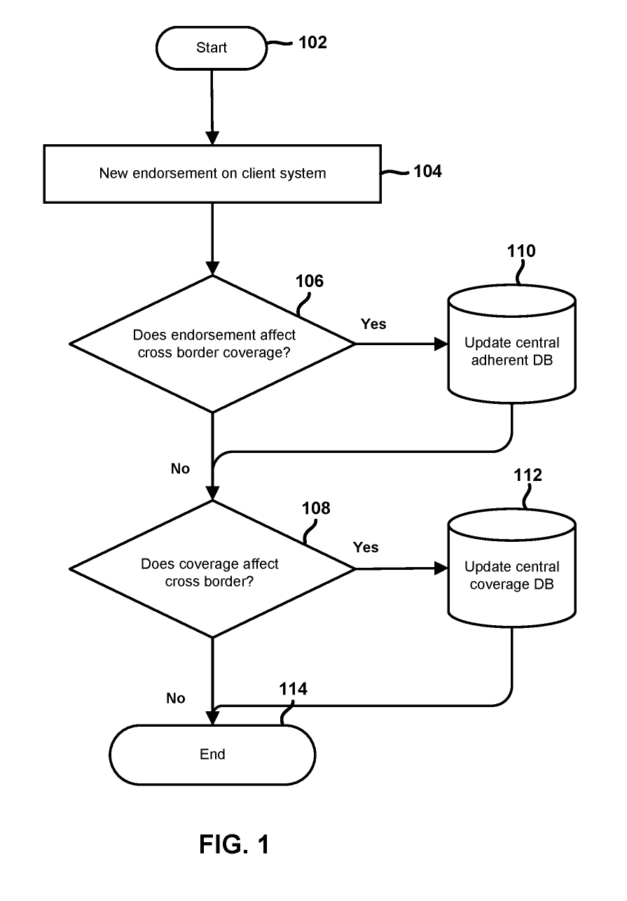

Initially, a method for providing healthcare insurance services to a beneficiary outside of a home boundary of the beneficiary, also called “cross-border coverage” herein, may include the process, shown generally at 100, of enrolling a new member or an existing member of the healthcare insurer's network into the cross-border coverage program, as shown in FIG. 1. Areas inside a “home boundary” of the beneficiary and areas outside of the “home boundary” may indicate, for example, a demarcation between countries, between states within a country, cities or municipalities within a state, or further divisions of localities within an area based on governmental or other lines of control or other boundaries.

According to FIG. 1, the process starts at step 102. At 104, a new endorsement is provided on the client system of the healthcare insurer's network for the new or existing member. At step 106, a determination is made as to whether the new endorsement affects the cross-border coverage eligibility program provided by a healthcare insurance provider. For instance, if the new or existing member is already enrolled in the cross-border coverage program (answer at step 106 is “no”), the method proceeds to step 108. However, if the new endorsement affects the cross-border coverage program, then a central adherent or beneficiary database is updated, at step 110.

Upon updating the central adherent database (at step 110) or determining that the new endorsement does not affect the cross-border coverage program (at step 106), a determination is made as to whether there are insurance coverage changes for the new endorsement that are effective across the borders of various locations that are part of the cross-border coverage program, at step 108. If there are coverage changes that have an affect across the borders, then a central coverage database for the cross-border coverage program is updated, at step 112. Upon updating the central coverage database (at step 112) or determining that there are coverage changes that do not have an affect across the borders (at step 108), the process 100 of enrolling a new member or an existing member of the healthcare insurer's network into the cross-border coverage program is completed, at step 114.

### Eligibility

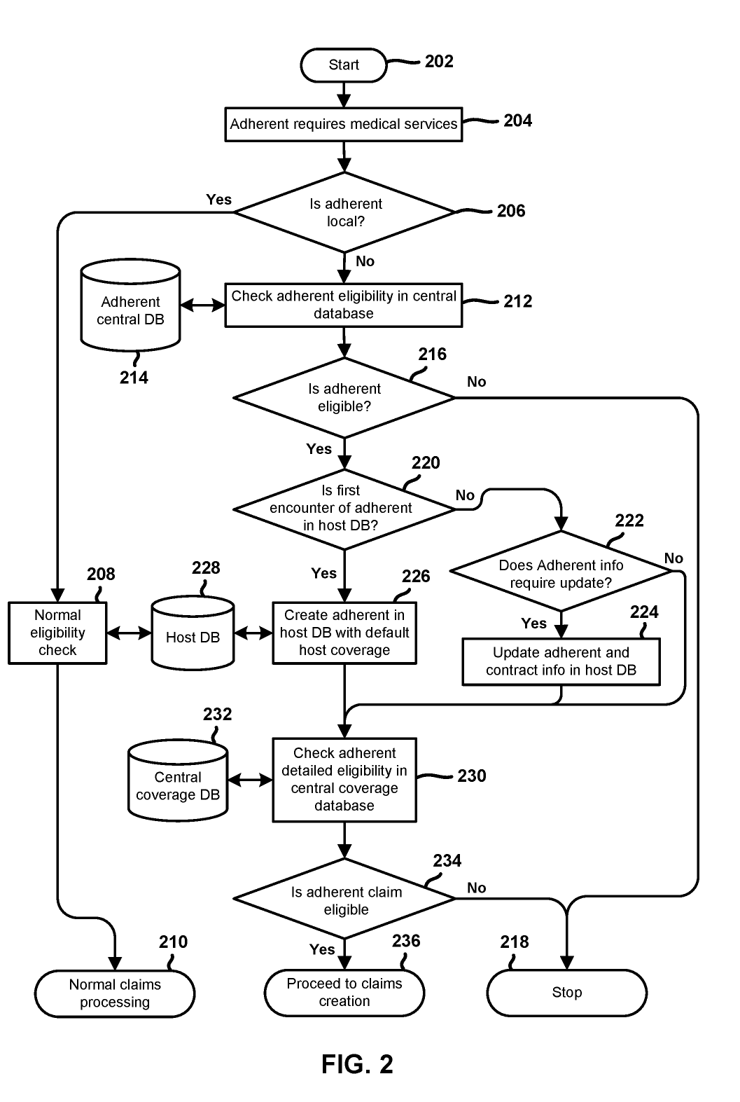

As shown in FIG. 2, after a new or existing member is enrolled in the cross-border coverage program, an eligibility method 200 is initiated when an adherent requires medical services. The method 200 is initiated at step 202 and includes receiving, at step 204, a request to provide healthcare services to a beneficiary from a healthcare provider at a first location. A beneficiary may be provided with a healthcare access card which facilitates the request to provide healthcare services to the beneficiary.

The healthcare access card provides access to healthcare services to be received by the beneficiary inside or outside of the home boundary of the beneficiary on direct billing basis. With a swipe of the card, similar to that of a credit card, healthcare providers may directly access a beneficiary's insurance policy benefits and requirements. This allows a beneficiary member of the healthcare insurer's network to enjoy medical attention at contracted or agreed to medical facilities, whether the beneficiary is seeking a simple consultation, general or emergency physician services, dental or vision care, pharmacy services, etc., in an expedient manner

At step 206, it is determined whether the first location of the healthcare provider is within or outside of the home boundary of the beneficiary—in other words, is the adherent or beneficiary local to the first location of the healthcare provider? If the first location of the healthcare provider is local to the adherent or beneficiary, meaning the beneficiary is within the home boundary, a normal eligibility check is undertaken, at step 208, which involves checking the host database of the healthcare insurer. If the healthcare services requested for the beneficiary are eligible, then the request is processed under a normal claim processing procedure, at step 210.

If the first location of the healthcare provider is outside of the home boundary, meaning the first location is not local to the adherent or beneficiary, eligibility for the cross-border claim is determined, at step 212. As shown in FIG. 2, initially, a check is made, at step 212, to the adherent central database, shown at 214, to determine if the adherent is enrolled in the cross-border coverage program. If, at step 216, the adherent is determined to be outside of the cross-border coverage program and ineligible at this point, the process ends, at step 218, and no claim for the request to provide healthcare services is created or processed.

If the adherent is determined to be enrolled in the cross-border coverage program and eligible, at step 216, the method proceeds with determining, at step 220, if this is the first encounter with the adherent in the host database. If it is not the first encounter in the host database, a determination is made, at step 222, as to whether the adherent information requires updating. If an update is required, information is received and stored in the host database, at step 224. This information may include any amount of personal information typically collected by a healthcare insurer. Additionally, periodic updates may be made to the host database, and any other databases involved, based on information manually input by the adherent or beneficiary, manually input by an individual associated with the healthcare insurer controlling the database, and/or automatically based on information by the healthcare insurer.

Upon determining that it is the adherent's first encounter in the host database, at step 220, a profile may be created and stored in the host database with default host coverage, at step 226. Creating the adherent profile in the host database, shown at 228, may involve a normal eligibility check, at step 208. The default host coverage may include limitations of the types of healthcare services provided, a coverage amount limit, limitations that only certain locations outside of the home boundary are provided coverage for, or any other limitations, such as, but not limited to, legal, regulatory and/or tax issues specific to certain countries or areas, that may be appreciated by one of ordinary skill in the art.

The method 200 then proceeds with step 230, where the adherent's eligibility for cross-border is checked in the central coverage database, the details of the coverage and related claims adjudication rules related to the healthcare policy are retrieved from the client system, shown at 232. Determining the eligibility of the beneficiary at this point may include determining a legal and/or regulatory scheme or structure present in the first location applicable to the healthcare services that are offered or provided by the healthcare provider at the first location. In a preferred embodiment, this may also include determining a taxation scheme or structure in the first location and the type of the healthcare services that are offered by healthcare providers at any possible location and/or those being requested to be provided.

If it is determined that the adherent's claim is eligible at step 234, the method proceeds to a claims creation process, at step 236. If it is determined at step 234 that the adherent's claim is not eligible, the process ends at step 218.

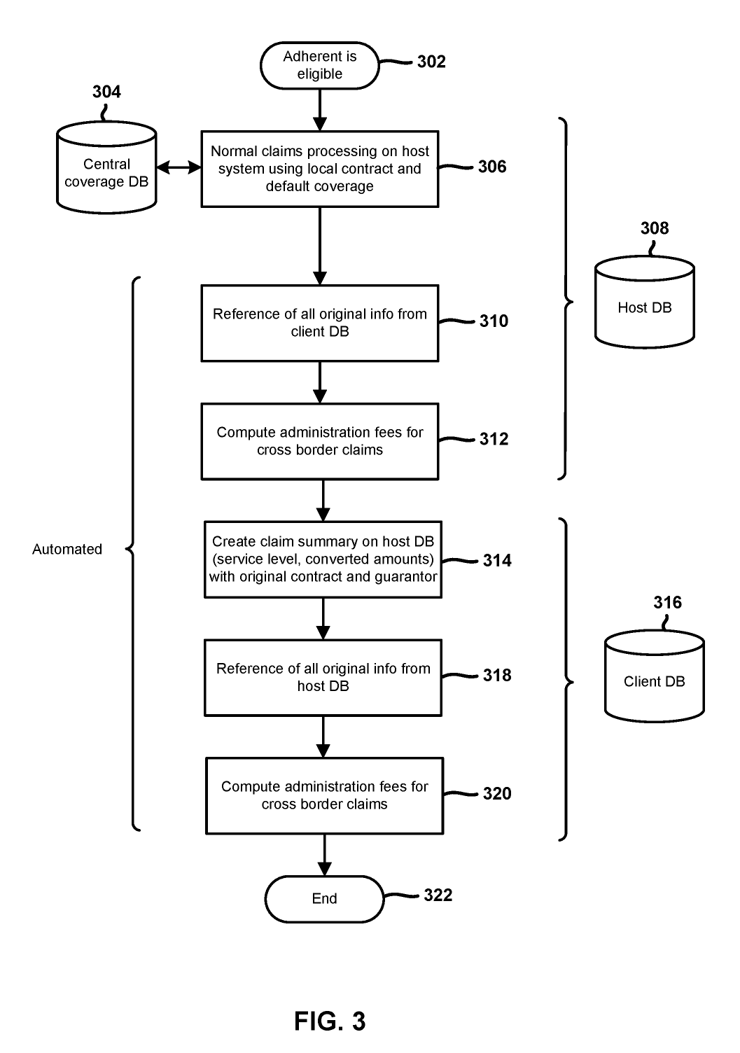

Following a determination that the healthcare services requested for the adherent are eligible at steps 234 and 236, the method proceeds to a claims creation process 300, as shown in FIG. 3. The adherent's claim is initially processed under normal claim processing on the host system using the local contract, obtained from the host database 308, and coverage amounts, obtained from the client database in location where policy was issued 316, at step 306. This may take place on a host system or database 308, which is described below, based on a local contract and a default coverage plan or program.

At the host database 308, the original information regarding the adherent and the requested healthcare services are referenced from the client database, at step 310. If the first location of the healthcare provider is not local to the beneficiary, and outside of the home boundary of the beneficiary, the cross-border claim is processed by computing any administration fees for the cross-border claim, at step 312.

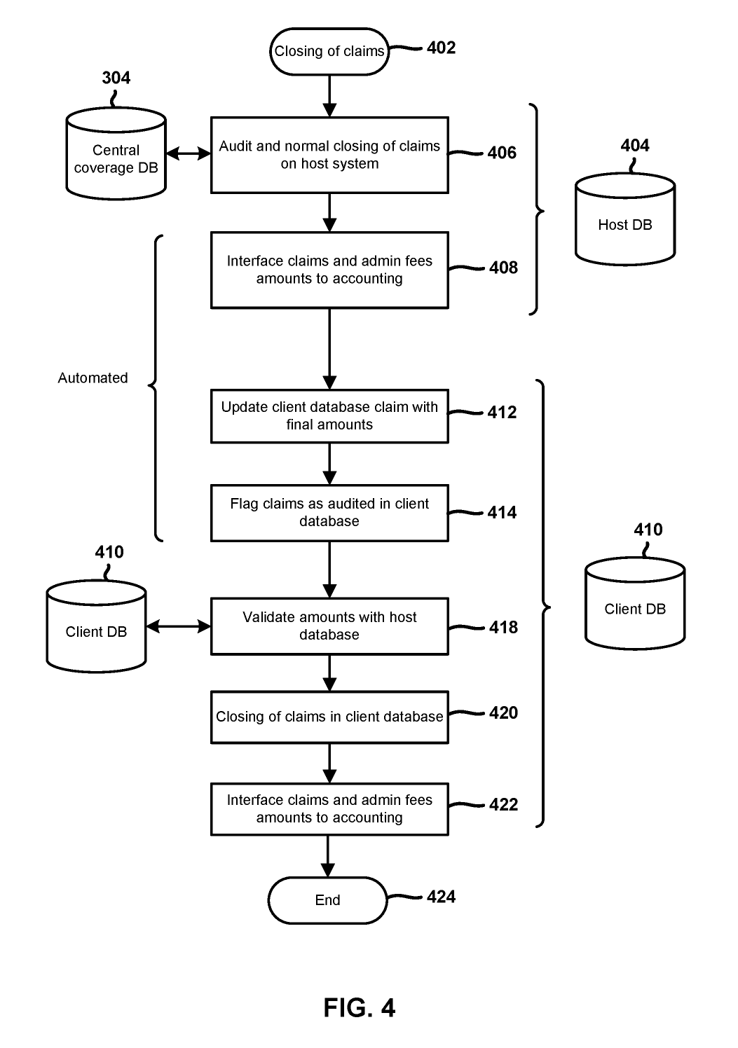

A claim summary for the cross-border, or other, claim is created, at step 314, on the host database 308, which includes the service level and/or type of healthcare services along with a converted amount for the claim summary The claim summary is based on an original contract between the beneficiary and the health insurer and an original guarantor. At the client database 316, the original information regarding the beneficiary and the requested healthcare services are referenced, at step 318, from the host database 308, and any administration fees for any cross-border claims are computed, at step 320. The method 300 then ends at step 322. It is contemplated that in order to expedite the processing of claims, steps 306, 310, 312, 314, 318 and 320 are performed at the healthcare insurance provider in an automated fashion. Once the local or cross-border claim has been processed, the method then proceeds to a claim closing procedure shown generally at 400 in FIG. 4. As shown in FIG. 4, the claim closing procedure begins at step 402, and includes performing an audit and normal closing of claims on the host 404, at step 406. A cross-border claim may further include interfacing the cross-border claim and administration fee amounts to accounting with regard to the host database 404, at step 408. The client database 410 is updated with a final amount, at step 412, and the cross-border and other claim is flagged as audited in the client database 410, step 414. It is contemplated that in order to expedite the processing and closing of claims, steps 408, 412 and 414 are performed at the healthcare insurance provider in an automated fashion.

Amounts of the cross-border or other claim are validated with the host database 416, at step 418, and the claims are closed in the client database 410, at step 420. Upon closing the claims, the claims and the associated administration fees are interfaced to accounting, at step 422, with regard to the client database 410. The method 400 then ends at step 424.

### Computer System Architecture

Embodiments of the present disclosure may be directed to computer program products including software stored on any computer useable medium. Such software, when executed in one or more data processing device, causes a data processing device(s) to operate as described herein. Embodiments of the present disclosure employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nano-technological storage device, etc.), and communication mediums (e.g., wired and wireless communications networks, local area networks, wide area networks, intranets, etc.).

Accordingly, it will be appreciated that one or more embodiments of the present disclosure can include a computer program including computer program code means adapted to perform one or all of the steps of any methods or claims set forth herein when such program is run on a computer, and that such program may be embodied on a computer readable medium. Further, one or more embodiments of the present disclosure can include a computer including code adapted to cause the computer to carry out one or more steps of methods or claims set forth herein, together with one or more apparatus elements or features as depicted and described herein.

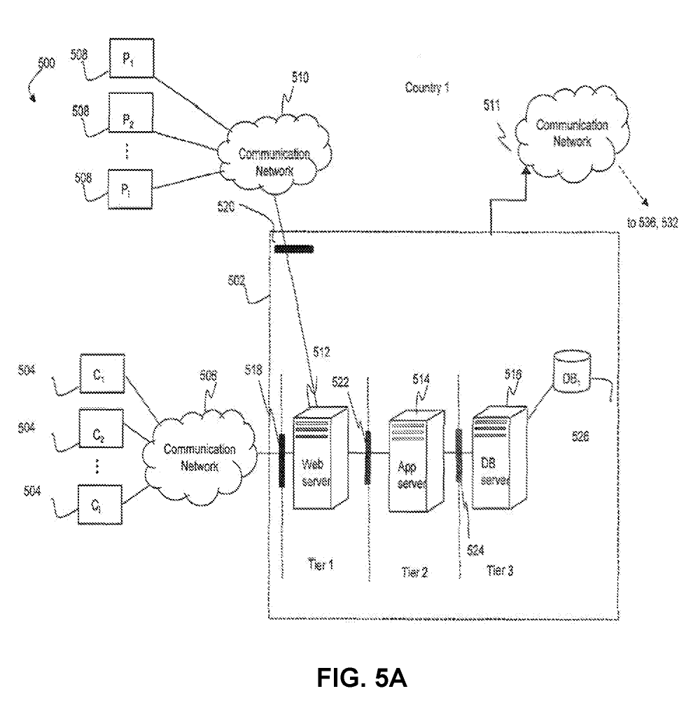

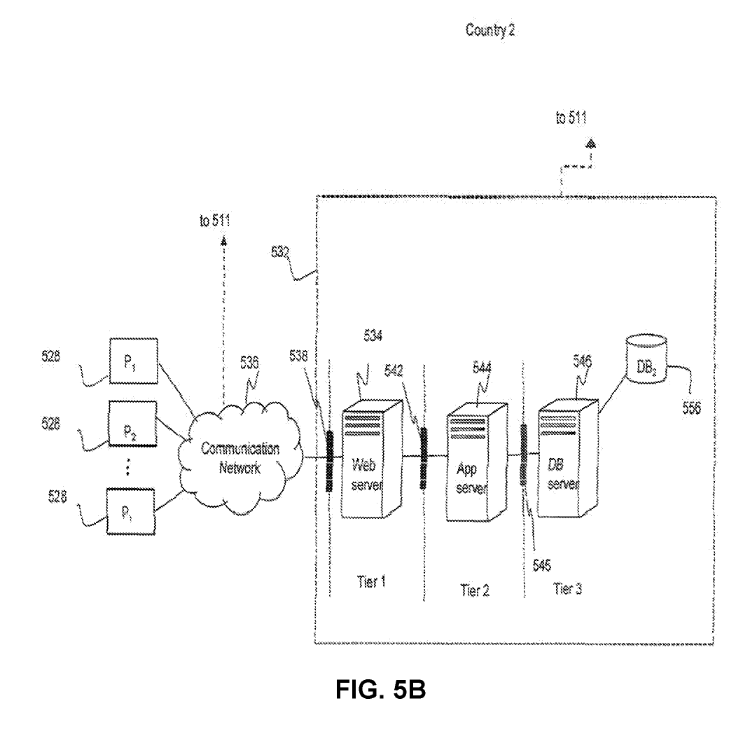

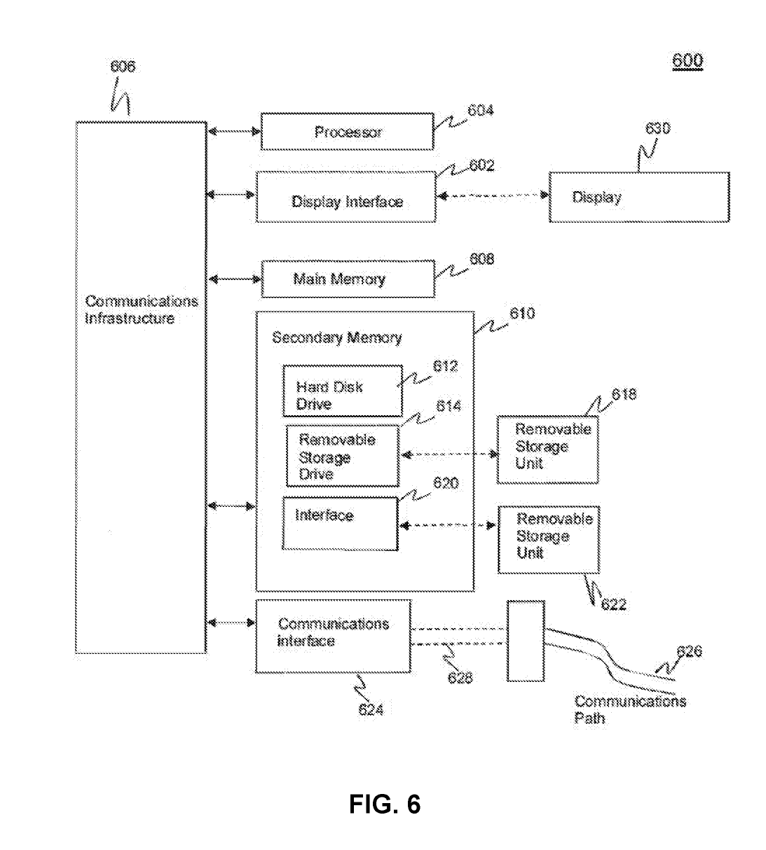

FIGS. 5A, 5B, and 6 illustrate communications network architecture and systems, respectively for providing healthcare insurance services to a beneficiary outside of a home boundary of the beneficiary as discussed and described above. The exemplary communications network architecture and computer systems depicted in FIGS. 5 and 6 may include a healthcare insurance provider's or healthcare services provider's communications network and computer system, respectively.

FIGS. 5A and 5B illustrates a system 500 according to embodiments of the present disclosure for providing communication network-based access to insurance payments and coverage for healthcare services for healthcare providers. As shown in FIG. 5A, the system 500 includes a host system 502 in communication with one or more first client devices C₁, C₂, . . . , Cᵢ 504 (hereinafter referred to as “clients 504”) via a first communication network 506. The host system 502 is located in a first country as shown in the example of FIG. 5A, but may be located in another type of demarcation boundary as consistent with this disclosure. Additionally, the host system 502 is in communication with or one or more second client devices P₁, P₂, . . . , Pᵢ 508 (hereinafter referred to as “clients 508”) via a second communications network 510. The communications networks 506, 510 may be the Internet, although it will be appreciated that any public or private communication network, using wired or wireless channels, suitable for enabling the electronic exchange of information between the clients 504, 508 and the host system 502 may be utilized.

The host system 502 may be implemented by a healthcare insurance provider or healthcare services provider (hereinafter referred to as “host institution”) and is configured to provide network-based product and service features to the clients 504, 508 and users (e.g., healthcare providers seeking payment of healthcare services from the host institution 502) associated with the clients 504, 508. The clients 504, 508 may include any form of mobile or portable device and any suitable network-enabled devices such as, for example, PCs, laptop computers, palmtop computers, mobile phones, mobile tablets, PDAs, etc. configured to transmit and receive information via the communications networks 506, 510 using wired or wireless connections.

In some embodiments, the host system 502 may be based on a tiered network architecture, and includes a web server 512 (Tier 1), an application server 514 (Tier 2), and a database server 516 (Tier 3). The web server 512 corresponds to the first tier of the host system 502 and is configured to communicate with the communication networks 506, 510 via border firewalls 518, 520, respectively, and with the application server 514 via an application firewall 522. The web server 512 may be configured to accept information requests, such as, for example, HTTP requests, from one or more of the clients 504, 508 via the communication networks 506, 510 and provide responses thereto. The responses may include, for example, HTTP responses including static and/or dynamic HTML documents for providing a user interface (“UI”) to users via the clients 504, 508. Additionally, the web server 512 may further be configured to authenticate each user before allowing access to a UI and other resources associated with the host system 502. Authentication may be performed, for example, by the user inputting a user name and a password.

The application server 514 corresponds to the second tier of the host system 502 and is configured to communicate with the web server 512 via the application firewall 522, and with the database server 516 via an internal firewall 524. The application server 514 may host one or more applications executing logic to provide healthcare insurance payment associated features to each user via their respective UI. The application server 514 receives user-entered information (e.g., user name and password associated with the user and a request to access particular healthcare insurance payment or reimbursement features) from the UI of each of the clients 504, 508 via the web server 512. Based on this and other information received from the clients 504, 508, applications hosted by the application server 514 may be invoked to perform financial and other transactions (e.g., transfer funds between accounts, retrieve account balances, receive payments, create new accounts, process claims, create adherent accounts, etc.) and generate corresponding informational content (e.g., transfer confirmations, account balance information, payment confirmation, account creation confirmation, claims processing information, claims payment information, claim approval/denial information, etc.). Information regarding such transactions and claims may be communicated to the web server 512 and subsequently presented to the users using, for example, a dynamic web page of the UI.

The database server 516 corresponds to the third tier of the host system 502 and is configured to communicate with the application server 514 via the internal firewall 524. The database server 516 manages one or more databases DB1 526 (hereinafter referred to as “databases 526”) which store data to support one or more applications hosted by the application server 514 or elsewhere. Such databases 526 may include, for example, host information databases, adherent information databases, coverage information databases, adherent account configuration databases, client databases, document identification/authentication databases, user information databases, user identification/authentication databases, user preferences/settings databases, as well as databases for storing other settings and/or configuration data. Database information requested by a particular application is retrieved from the databases 526 by the database server 516, communicated to the requesting application, and updated by the database server 516 as needed.

The clients 504, 508, as discussed above, may be PCs and/or other network-enabled devices (e.g., cell phones, mobile phones, mobile tablets, PDAs, etc.) configured to transmit and receive information via the communication networks 506, 510 using a wired or wireless connection. The clients 504, 508 may include a suitable browser software application (e.g., Internet Explorer, Internet Explorer Mobile, Firefox, Blazer, etc.) for enabling the user to display and interact with information exchanged via the communication networks 506, 510. The clients 504, 508 may thus access and navigate static and/or dynamic HTML documents of the UI.

Further, as shown in FIG. 5B, the system 500 may include an outside system 532 in communication with one or more client devices P₁, P₂, . . . , Pᵢ 528 (hereinafter referred to as “clients 528”) via an additional communication network 536. The outside system 532 is located in a second country as shown in the example of FIG. 5B, but may be located in another type of demarcation boundary as consistent with this disclosure. Additionally, the outside system 532 may be in communication with or one or more second client devices (not shown) via the communications network 536 or another communications network. The communications network 536 may be the Internet, although it will be appreciated that any public or private communication network, using wired or wireless channels, suitable for enabling the electronic exchange of information between the clients 528 and the outside system 532 may be utilized.

The outside system 532 may be implemented by a healthcare insurance provider or healthcare services provider (hereinafter referred to as “healthcare institution”) and is configured to provide network-based product and service features to the clients 528 and users (e.g., healthcare providers seeking payment of healthcare services from the host institution 502 and/or healthcare institution 532) associated with the clients 528. The clients 528 may include any form of mobile or portable device and any suitable network-enabled devices such as, for example, PCs, laptop computers, palmtop computers, mobile phones, mobile tablets, PDAs, etc. configured to transmit and receive information via the communications networks 536 using wired or wireless connections.

Similar to the embodiment shown in FIG. 5A, in some embodiments, the outside system 532 and may be based on a tiered network architecture, and includes a web server 534 (Tier 1), an application server 544 (Tier 2), and a database server 546 (Tier 3), respectively. The web server 534 corresponds to the first tier of the outside system 532 and is configured to communicate with the communication network 536 via border firewall 538 and with the application server 544 via an application firewall 542. The web server 534 may be configured to accept information requests, such as, for example, HTTP requests, from one or more of the clients 528 via the communication network 536 and provide responses thereto. The responses may include, for example, HTTP responses including static and/or dynamic HTML documents for providing a user interface (“UI”) to users via the clients 528. Additionally, the web server 534 may further be configured to authenticate each user before allowing access to a UI and other resources associated with the outside system 532. Authentication may be performed, for example, by the user inputting a user name and a password.

The application server 544 corresponds to the second tier of the outside system 532 and is configured to communicate with the web server 534 via the application firewall 542, and with the database server 546 via an internal firewall 545. The application server 544 may host one or more applications executing logic to provide healthcare insurance payment associated features to each user via their respective UI. The application server 544 receives user-entered information (e.g., user name and password associated with the user and a request to access particular healthcare insurance payment or reimbursement features) from the UI of each of the clients 528 via the web server 534. Based on this and other information received from the clients 528, applications hosted by the application server 544 may be invoked to perform financial and other transactions (e.g., transfer funds between accounts, retrieve account balances, receive payments, create new accounts, process claims, create adherent accounts, etc.) and generate corresponding informational content (e.g., transfer confirmations, account balance information, payment confirmation, account creation confirmation, claims processing information, claims payment information, claim approval/denial information, etc.). Information regarding such transactions and claims may be communicated to the web server 534 and subsequently presented to the users using, for example, a dynamic web page of a UI.

The database server 546 corresponds to the third tier of the outside system 532 and is configured to communicate with the application server 544 via the internal firewall 545. The database server 546 manages database DB2 556 (hereinafter referred to as “databases 556”) which store data to support one or more applications hosted by the application server 544 or elsewhere. While not shown, other databases may also be present and managed by the database server 546. Such databases 556 may include, for example, host information databases, adherent information databases, coverage information databases, adherent account configuration databases, client databases, document identification/authentication databases, user information databases, user identification/authentication databases, user preferences/settings databases, as well as databases for storing other settings and/or configuration data. Database information requested by a particular application is retrieved from the databases 556 by the database server 546, communicated to the requesting application, and updated by the database server 546 as needed.

The clients 528, as discussed above, may be PCs and/or other network-enabled devices (e.g., cell phones, mobile phones, mobile tablets, PDAs, etc.) configured to transmit and receive information via the communication network 536 using a wired or wireless connection. The clients 538 may include a suitable browser software application (e.g., Internet Explorer, Internet Explorer Mobile, Firefox, Blazer, etc.) for enabling the user to display and interact with information exchanged via the communication network 536. The clients 528 may thus access and navigate static and/or dynamic HTML documents of a UI.

The host system 502 and outside system 532 may communicate via communication network 511. Additionally, the clients 528 may communicate directly with the host system 502 via communication networks 536 and 511. The communications network 511 may be the Internet, although it will be appreciated that any public or private communication network, using wired or wireless channels, suitable for enabling the electronic exchange of information between the host system 502 and outside system 532 may be utilized. A firewall may or may not be applied at other end of the communication network 511 for host system 502 and outside system 532, respectively.

As would be appreciated by one skilled in the relevant art(s) and described below with reference to FIG. 6, part or all of one or more aspects of the methods and systems discussed herein may be distributed as an article of manufacture that itself includes a computer readable medium having computer readable code means embodied thereon.

The computer readable program code means is operable, in conjunction with a computer system, to carry out all or some of the steps to perform the methods or create the apparatuses discussed herein. The computer readable medium may be a recordable medium (e.g., hard drives, compact disks, EEPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, for example, by processing capability on mobile device, POS terminal, payment processor, acquirer, issuer, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor.

Aspects of the present disclosure shown in FIGS. 1-4, or any part(s) or function(s) thereof, may be implemented using hardware, software modules, firmware, tangible computer readable media having instructions stored thereon, or a combination thereof and may be implemented in one or more computer systems or other processing systems.

FIG. 6 illustrates an example computer system 600 in which embodiments of the present disclosure, or portions thereof, may be implemented as computer-readable code. For example, the various aspects and computer devices used to effectuate the steps shown in the flowcharts depicted in FIGS. 1-4 can be implemented in the computer system 600 using hardware, software, firmware, non-transitory computer readable media having instructions stored thereon, or a combination thereof and may be implemented in one or more computer systems or other processing systems. Hardware, software, or any combination of such may embody any of the modules and components used to implement the systems and methods described below and in FIGS. 1-4.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments. A processor device may be a single processor, a plurality of processors, or combinations thereof. Processor devices may have one or more processor “cores”.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

The computer system 600 includes a display 630 connected to a communications infrastructure 606 via a display interface 602. In an embodiment, the display 630, in conjunction with the display interface 602, provides a user interface (UI) for clients and purchasers. The computer system 600 also includes a processor device 604, which may be a special purpose or a general purpose processor device. As will be appreciated by persons skilled in the relevant art, the processor device 604 may also be a single processor in a multi-core/multiprocessor system, such system operating alone, or in a cluster of computing devices operating in a cluster or server farm. The processor device 604 is connected to the communication infrastructure 606, for example, by a bus, message queue, network, or multi-core message-passing scheme.

The computer system 600 also includes a main memory 608 (e.g., random access memory, read only memory, etc., and may also include a secondary memory 610. Secondary memory 610 may include, for example, a hard disk drive 612 and a removable storage drive 614, such as, for example, a floppy disk drive, a magnetic tape drive, an optical disk drive, a flash memory, etc.

The removable storage drive 614 may read from and/or writes to a removable storage unit 618 in a well-known manner The removable storage unit 618 may include a floppy disk, magnetic tape, optical disk, Universal Serial Bus (“USB”) drive, flash drive, memory stick, etc. which is read by and written to by removable storage drive 614. As will be appreciated by persons skilled in the relevant art, the removable storage unit 618 includes a non-transitory computer usable storage medium having stored therein computer software and/or data.

In alternative implementations, the secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to the computer system 600.

The computer system 600 may also include a communications interface 624. The communications interface 624 allows software and data to be transferred between the computer system 600 and external devices. The communications interface 624 may include a modem, a network interface (such as an Ethernet card), a communications port, a PCMCIA slot and card, or the like. Software and data transferred via the communications interface 624 may be in the form of signals 628, which may be electronic, electromagnetic, optical, or other signals capable of being received by communications interface 624. These signals 628 may be provided to the communications interface 624 via a communications path 626. The communications path 226 carries the signals 628 and may be implemented using wire or cable, fiber optics, a phone line, a cellular/wireless phone link, an RF link or other communications channels.

In this document, the terms “computer program medium,” “non-transitory computer readable medium,” and “computer usable medium” are used to generally refer to tangible media such as removable storage unit 618, removable storage unit 622, and a hard disk installed in hard disk drive 612. Signals carried over the communications path 626 can also embody the logic described herein. The computer program medium and computer usable medium can also refer to memories, such as main memory 608 and secondary memory 610, which can be memory semiconductors (e.g., DRAMs, etc.). These computer program products are means for providing software to computer system 600.

Computer programs (also called computer control logic and software) are generally stored in a main memory 608 and/or secondary memory 610. The computer programs may also be received via the communications interface 624. Such computer programs, when executed, enable computer system 600 to become a specific purpose computer able to implement the present disclosure as discussed herein. In particular, the computer programs, when executed, enable the processor device 604 to implement the processes of the present disclosure discussed above. Accordingly, such computer programs represent controllers of the computer system 600. Where the present disclosure is implemented using software, the software may be stored in a computer program product and loaded into the computer system 600 using the removable storage drive 614, interface 620, and hard disk drive 612, or communications interface 624.

As discussed above, the various embodiments include methods, and computing systems configured to implement the methods, of providing cross-border health coverage. A computing system may be configured to receive a request to provide healthcare services to an adherent/beneficiary from a healthcare provider that is at a first location, identify a home boundary of the adherent/beneficiary, determine whether the first location (of the healthcare provider) is within the home boundary, perform a cross-border eligibility check to determine whether the adherent/beneficiary is eligible to receive the healthcare services outside the home boundary in response to determining that the first location (of the healthcare provider) is not within the home boundary, compute a contract price for the healthcare services, compute administration fees, generate a claim summary (e.g., a summation of a contract price value and one or more administration fee values, etc.), validate the computed amounts, and send claim summary to an accounting system computing device.

Generally, a healthcare provider (e.g., doctor, hospital, etc.) provides healthcare services to patients (e.g., an adherent, beneficiary, etc.), and charges insurance providers (i.e., healthcare guarantors) for that care. International private medical insurance (iPMI) policies allow members to receive treatment in other countries and offer their healthcare providers the assurance that they'll be paid for their services. Most iPMI policies require patients to make payment before, or very soon after, receiving treatment, then submit a claim to their healthcare guarantor for reimbursement. This is often a tedious and complicated process that places the risk of non-reimbursement on the patient. For this reason, many patients do not purchase or use iPMI policies, healthcare providers do not support such plans, and healthcare guarantors do not generate sufficient revenue from such plans.

Some iPMI policies allow for direct settlement, in which the healthcare provider (e.g., doctor, hospital, etc.) submits a claim directly to the healthcare guarantor (e.g., insurance company, etc.) on the adherent/patient's behalf However, in order for these polices to be useful and effective, the healthcare guarantor is often required to enter into complex agreements with many different healthcare providers in many different countries and/or to use direct intermediaries that approve and settle claims. This may require manual, inefficient and time-consuming analysis, cumbersome processing and expensive intermediaries, any or all which may increase the costs associated with iPMI policies and/or otherwise discourage patients, healthcare providers, and healthcare guarantors from offering, purchasing, supporting, or using iPMI policies.

In addition, because the healthcare providers are in different countries, they often operate using different languages, use different medical codes, offer a different set of medical services, have different compliance requirements and guidelines, implement different quality and safety procedures, and use different (and often incompatible) computing systems. These and other complexities introduce technical challenges and inefficiencies that further increase the costs associated with providing iPMI policies on a direct settlement basis. For these additional reasons, many patients do not purchase or use iPMI policies, healthcare providers do not support such plans, and healthcare guarantors do not generate sufficient revenue from such plans.

The embodiments above introduce new claim approval and settlement methods that overcome, override, automate some of the complexities and technological problems associated with handling and managing medical claims between separate healthcare insurance computer networks that are associated with different parties in different territories/countries. As a result, the embodiments improve the efficiency, performance and functioning of the healthcare system, as well as the components and computing devices that implement the healthcare system. These improvements may greatly reduce the costs associated with providing iPMI policies on a direct settlement basis, assure healthcare providers that they'll be paid for their work, and allow patients to receive healthcare services from many different healthcare providers in many different countries.

A computing system configured in accordance with the various embodiments (e.g., a healthcare guarantor computing system, a healthcare provider computing system, etc.) may create a direct and immediate interface between two or more entities in several different territories. Each territory may be serviced by a different healthcare insurance computer network that is involved in the medical claim of a patient/adherent. The computing system/interface may allow different networks in different territories to cooperatively approve and settle claims without prior arrangements or direct intermediaries between the networks. As a result, computing system/interface may improve the performance and functioning of the healthcare system, as well as the components and computing devices that implement the healthcare system. For example, the various embodiments improve the performance and functioning of computing systems that validate healthcare coverage (e.g., healthcare guarantor computing system, healthcare provider computing system, etc.). These improvements reduce the operations costs associated with providing iPMI policies on a direct settlement basis, enable healthcare guarantors to provide more robust plans, assure healthcare providers that they'll be paid for their work, and encourage patients to purchase and use iPMI policies.

Some embodiments may generate and use proxy providers and proxy guarantors (proxy insurance providers) that seamlessly integrate the separate networks, and at the same time, hide some of the complexities of providing cross border healthcare insurance.

In some embodiments, the cross-border system may include a proxy provider component and a proxy guarantor component. In some embodiments, the proxy provider component and/or the proxy guarantor component may be included in, or as part of, the healthcare guarantor computing system and/or the healthcare provider computing system, respectively. The proxy guarantor component may eliminate, hide or reduce the complexities of interacting with multiple different healthcare guarantor systems from the actual healthcare provider. The proxy provider component may eliminate, hide or reduce complexities of interacting with a multitude of different healthcare provider systems from the actual healthcare guarantor system.

As an example, assume United Health Group is a healthcare guarantor administering the policy of a member (John Doe) in the U.S. Dr. X is the healthcare provider in Mexico that is contracted with a local company (MyHealthServices) to provide services to members that are managed by MyHealthServices. MyHealthServices has contractual arrangements in place for managing claims from United Health Group, Aetna, Axa PPP in Europe, and many others. Dr. X does not know of United Health Group or any of the healthcare guarantors that have contracted with MyHealthServices. Nor do Dr. X and the healthcare guarantors (e.g., United Health Group) have a prior claim or healthcare-related relationship with one another.

John Doe travels to Mexico and wants to get healthcare services rendered by Dr. X on a direct settlement basis. By utilizing proxy providers and proxy guarantors, the various embodiments enable John Doe to receive services without incurring any out of pocket expenses at the time of the visit, and for Dr. X to get immediate approval and a guarantee of payment from MyHealthServices. That is, the use of the proxy guarantor and proxy provider allow John Doe to receive medical services in Mexico, and return to the U.S. without paying any out of pocket expenses or having to file any further claims or documentation to United Health Group. In addition, by using the proxy guarantor/provider system, Dr. X does not need to know United Health Group or its processes. Rather, to obtain approval, Dr. X follows the process set by MyHealthServices by logging on to its healthcare computer network system (MHS System) and executing the normal automated approval process.

The MHS System is configured to recognize that there is a John Doe that is covered by United Health Group at the same time the healthcare computer system of United Health Group (UHG System) is configured to recognize that there is a virtual provider named MyHealthServices that acts as a proxy to all healthcare providers in Mexico. In addition, both the MHS System and the UHG System are configured to interface with each other, use different currency codes and exchange rates, use different medical code (ICD codes) versions, and map the different versions to resident codes and rates. On a daily basis, the UHG System automatically communicates to MHS System data identifying members of United Health Group that can get services in Mexico (insurance number and name, etc.).

When John Doe goes to Dr. X, the following operations are performed. First, the Dr. X logs into the MHS System to check if John Doe is covered, and gets approval on the medical services to be performed as per MyHealthServices standard processes. Then, the MHS System checks the exchanges info and identifies John Doe as valid. The MHS System then communicates with UHG System and gets more details (is he still valid, full, name, date of birth, etc.). The MHS System creates a claim (ClaimB) with the John Doe's information and the medical details of the condition and services to be provided as entered by Dr. X as per Mexico's and/or MyHealthServices standards. The MHS System prices the claim and does all of the required checks related to Dr. X based on information available in the MHS System. The MHS System replaces the medical information of the claim (ClaimB) with the appropriate version required by the UHG System using the mapping information, updates the language (e.g., to English) and sends that information to the UHG System. In some embodiments, as part of these operations, the cross border system may implement and use the disease related condition (DRC) discussed further below.

The UHG System receives the information in the languages it understands, saves this information as a claim (ClaimA). The provider in ClaimA on the UHG System is not Dr. X, but MyHealthServices (this is because the UHG System does not know who Dr. X is). The UHG System conducts the eligibility check and automated controls on the claim, it sends back the results to the MHS System.

The MHS System updates ClaimB based on the results received from UHG System, and complements this with final checks before providing the information back to Dr. X.

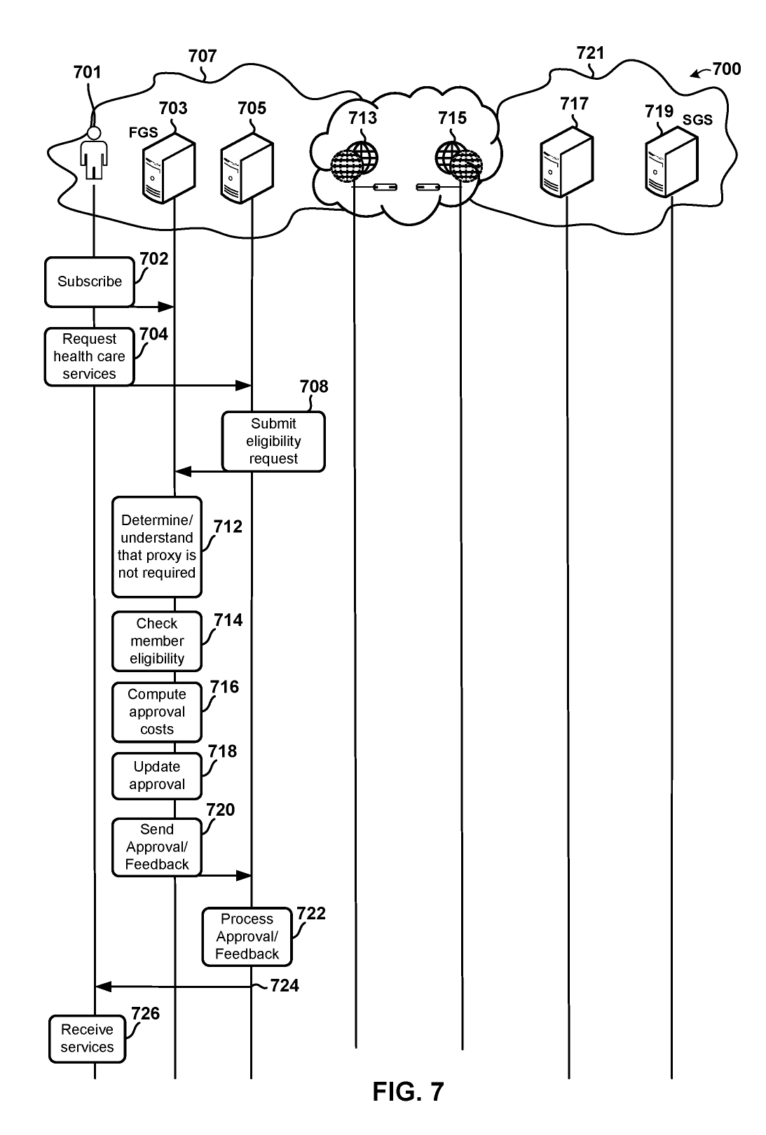

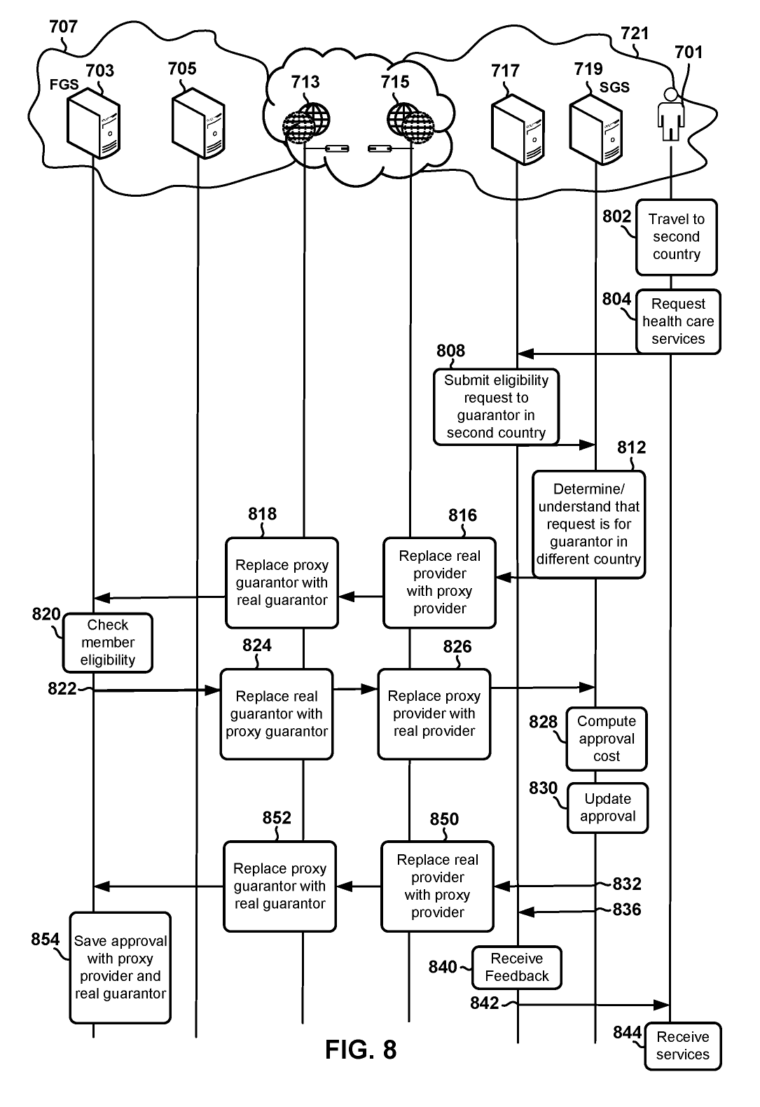

FIGS. 7 and 8 illustrate methods for providing health services in accordance with an embodiment. The methods may be performed in a system 700 that includes a member 701 (e.g., a user, consumer, adherent, beneficiary, etc.), a first guarantor system (FGS) 703, a second guarantor system (SGS) 719, a first provider system 705, a second provider system 717, a first proxy 713 and a second proxy 715. Each of the FGS 703, SGS 719, first provider system 705, second provider system 717, first proxy 713 and second proxy 715 may include, or may be implemented via, one or more processors in one or more computing systems, which may be included in, coupled to, or implement all or portions of the cross-border system discussed in this application. All or portions of the first and second proxies 713, 715 may be included as part of FGS 703 and/or SGS 719. In some embodiments, the FGS 703 and/or SGS 719 may be, may be included in, or may be include as part of, one or more healthcare guarantor computing systems.

The FGS 703 and first provider system 705 may be within or associated with a first country 707, and the second guarantor system 719 and second provider system 717 may be within or associated with in a second country 721. The FGS 703 and SGS 719 may each be associated with many insurance guarantors within their respective countries 707 and 721, but not those outside of their country. For example, the FGS 703 may be associated with an insurance provider (e.g., United Health Group, etc.) that has an existing relationship with a provider (e.g., Dr. Z) associated with the first provider system 705, but the FGS 703 and the first provider system 705 are not aware of, do not communicate with, and do not have any direct relationships with the SGS 719 or the second provider system 717.

The FGS 703 and the SGS 719 may each include a member identifier list that identifies each eligible member and the healthcare guarantor system associated with that member. The FGS 703 and the SGS 719 may be configured to periodically update and synchronize their lists and databases within the system 700.

In the example illustrated in FIG. 7, the member is within the first country 707. In the example illustrated in FIG. 8, the member travels to the second country 721.

With reference to FIG. 7, in operation block 702, the member 701 may subscribe to receive health insurance services from the FGS 703. In operation block 704, the member 701 may request to receive or procure healthcare services from a provider (e.g., Dr. Z) associated with the first provider system 705. As such, the first provider system 705 is the “real provider” in this example.

In operation block 708, the first provider system 705 may submit an eligibility request to FGS 703. In an embodiment, the first provider system 705 may access an online portal belonging to FGS 703 to submit the request in operation block 708.

In operation block 712, the FGS 703 may receive the eligibility request, and determine/understand that the request is directed to FGS 703 and can be processed locally. For example, the FGS 703 may identify the member 701, determine whether the member 701 is registered, determine whether the first country 707 is the country that includes the system in which the member 701 is registered, determine the current location of the member 701 and/or the provider (e.g., Dr. Z) associated with the first provider system 705, and determine whether the location(s) are within the first country 707. The FGS 703 may determine that it can process the eligibility request locally in response to determining that the subscriber is within the first country 707 and that the first country 707 is the country that includes the system in which the member 701 is registered. As a result, the FGS 703 may determine that it is the “real guarantor,” and does not have to employ the use of a proxy in operation block 712.

In operation block 714, the FGS 703 may check or determine the eligibility of the member 701 to receive the requested healthcare services. For example, the FGS 703 may query a local database to determine whether the member is registered with the system, subscribed to a plan that covers all or portions of the requested healthcare services, and that the subscription/policy is active or has not yet expired.

In operation block 716, the FGS 703 may compute or determine the insurance policy terms, the approval costs associated with the requested healthcare services, and the out of pocket expenses that the member 701 has to pay based on the insurance policy terms. In operation block 718, the FGS 703 may generate or update an approval message based on the determined eligibility and costs. In some embodiments, the FGS 703 may generate/update the approval message to include information that indicates that the eligibility request is accepted, rejected, or partially accepted, as well as other feedback (e.g., out-of-pocket expenses, reasons for denial, etc.). For example, the FGS 703 may determine that the member is member 701 is eligible to receive a portion of requested healthcare services, generate the approval message to indicate that the request is partially accepted (and identifying the portions accepted), and send the approval message and/or feedback to the first provider system 705 in operation block 718. In some embodiments, the FGS 703 may send the approval message and/or feedback to the first provider system 705 via the online portal.

In operation block 722, the first provider system 705 may receive and process the approval message and/or feedback from the FGS 703 to determine whether the eligibility request was accepted, rejected, or partially accepted.

In operation block 722, the first provider system 705 may notify the member whether the request was accepted, rejected, or partially accepted, and of the out of pocket expenses associated with the requested healthcare services. If accepted or partially accepted, and the member 701 selects to pay the out of pocket expenses, the member 701 may receive all or a portion of the requested services in operation block 726.

With reference to FIG. 8, in operation block 802, the member 701 (which subscribed to receive health insurance services from the FGS 703 in operation block 702), may travel to the second country 721. In operation block 804, the member 701 may request healthcare services from a provider associated with the second provider system 717. As such, the second provider system 717 is the “real provider” in this example.

In operation block 808, the second provider system 717 may receive the request for healthcare services from the member 701, generate a service eligibility message (e.g., a healthcare service eligibility request, etc.), and send the service eligibility message to the SGS 719 in the second country 721, which is the same country in which the same country in which the member 701 requested to receive healthcare services. In some embodiments, the second provider system 717 may access a SGS portal, and submit the service eligibility message/request directly via the SGS portal. In some embodiments, the SGS 719 and/or SGS portal may be included in a healthcare guarantor computing system.

In operation block 812, the SGS 719 may receive the service eligibility message from the second provider system 717 in the second country 721. The service eligibility message may include a member identifier (adherent identifier), a proxy guarantor identifier, a policy identifier, a service identifier (healthcare service identifier), a disease code, and other similar information.

Also in operation block 812, the SGS 719 may use the information included in the received service eligibility message to query locally stored lists/databases based on the member identifier and other lookup information, and use the results of the queries determine whether the member is a local member and/or to identify the healthcare guarantor system the member 701 is subscribed. The SGS 719 may determine whether the request is directed to the SGS 719 (i.e., whether it can service the request), whether the policy is associated with a second location, and/or whether it should employ the use of a proxy based on whether the member is a local member and/or the healthcare guarantor system to which the member 701 is subscribed. The SGS 719 may also determine a disease-related condition (DRC) that is associated with the disease code included in the service eligibility message.

In the example illustrated in FIG. 8, the SGS 719 determines that the member 710 is not a local member, the policy is associated with a second location, and/or that the member 710 is registered with a system in a different country. As such, the SGS 719 determines that the request is not directed to the SGS 719, and that it has to employ the use of a proxy. In response, the SGS 719 and/or the second proxy 715 may use the information included in the received the service eligibility message to generate a proxy eligibly request message. In some embodiments, the proxy eligibility request message may be generated so that it replaces an identifier of a healthcare provider (e.g., second provider system 717) with an identifier of a proxy provider or with a proxy provider ID. The SGS 719 and/or the second proxy 715 may send the proxy eligibility request and the determined DRC to the first proxy 713 and/or FGS 703.

In some embodiments, in optional operation block 816, the second proxy 715 may identify the first proxy 713 as a suitable proxy guarantor, replace the identifier of a healthcare provider with an identifier of a proxy provider in the proxy eligibility request message, and send the proxy eligibly request message to the first proxy 713. In optional operation block 818, the first proxy 713 may receive the proxy eligibility request message, identify as FGS 703 as including the real guarantor, replace the identifier of the proxy guarantor with an identifier of the real/actual guarantor, and send the proxy eligibly request message to FGS 703.

In operation block 820, the FGS 703 may receive the proxy eligibility request message and determined DRC, and check to determine the eligibility of the member 701 to receive the requested healthcare services. For example, the FGS 703 may query a local database to determine whether the member 701 is registered with the system and subscribed to a plan that covers all or portions of the requested healthcare services. The FGS 703 may also use the received information to determine whether the policy is valid, determine whether the member 701 is eligible to receive the healthcare service, determine whether the member 701 is subject to specific or general exclusions, determine whether the member 701 has exhausted or exceeded a policy limit, etc.

In operation 822, the FGS 703 and/or the first proxy 713 may generate a proxy approval confirmation message that includes information indicating whether the member 701 is eligible to receive all or part of the healthcare service. The proxy approval confirmation message may be generated so that it replaces an identifier of the actual guarantor (e.g., a guarantor registered with FGS 703, etc.) with the identifier of a proxy guarantor.

In optional operation 824, the first proxy 713 may identify the proxy provider, replace the identifier of the actual guarantor with the identifier of the proxy guarantor, and send the proxy approval confirmation message and/or the results of the eligibility determination to the proxy provider represented by the second proxy 715. In optional operation 826, the second proxy 715 may identify the real provider as the second provider system 712, replace the identifier of the proxy provider with the identifier of the real provider, and send the proxy approval confirmation message and/or the results of the eligibility determination to the SGS 719.

In operation 828, the SGS 719 may compute or determine the approval costs associated with the requested healthcare services. In operation block 830, the SGS 719 may generate or update an approval message based on the determined eligibility and costs. In some embodiments, the SGS 719 may generate/update the approval message to include information that indicates that the eligibility request is accepted, rejected, or partially accepted, as well as other feedback received from FGS 703 in operation block 820.

In some embodiments, in operation 828, the SGS 719 may generate the approval message based on a combination of the information included the proxy approval confirmation message (from the first proxy 713/FGS 703), the information included in the eligibility request message (from the second provider system 717), and information stored in a database/memory that is included in or otherwise coupled to the SGS 719. In an embodiment, the SGS 719 may generate the approval message based on feedback received from the FGS 703, disease code and/or healthcare service information received from the second provider system 717, and cost information retrieved from memory (or database) coupled to the SGS 719.

In operation 832, the SGS 719 may send an approval confirmation message to the second proxy 715. In operation 836, the SGS 719 may send the approval/feedback to the second provider system 717. In operation block 840, the second provider system 717 may receive and process the approval/feedback from the SGS 719 to determine whether the eligibility request was accepted, rejected, or partially accepted. In operation 842, the second provider system 717 may notify the member 701 whether the request was accepted, rejected, or partially accepted. If accepted or partially accepted, the member 710 may receive all or a portion of the requested services in operation block 844.

In optional operation block 850, the second proxy 715 may replace the real provider with a proxy provider, and send the approval message to the first proxy 713. In optional operation block 852, the first proxy 713 may replace the proxy guarantor with the real guarantor, and send the message to the FGS 703. In operation block 854, the FGS 703 may save the approval with the proxy provider and real guarantor. The FGS 703 may record the approval so that it may properly calculate insurance provisions as eventually this approval amount has to be paid. In addition, this approval is now part of the patient file, the amount approved is deducted from any limits the member has so that if future approvals are processed the amount of this approval is considered as utilized. Further, if the same member requests approvals for similar or other medical services they could be rejected for duplication or other reasons that are medically inconsistent or duplicate of the approved services in this transaction.

As mentioned above, in some embodiments, the cross border system may be configured to implement and use the disease related condition (DRC) codes to facilitate and automate the processing of eligibility requests (e.g., as part of the operations in blocks 714 and 820 illustrated in FIGS. 7 and 8, etc.).

Generally, when an adherent subscribes to a healthcare insurance policy, the healthcare guarantor uses disease or ICD codes to identify the medical conditions, diseases, diagnoses, symptoms, and/or procedures that are allowed, limited, and/or excluded under the healthcare insurance policy. For example, to indicate a general exclusion (GE) for all congenital cases, a healthcare guarantor may identify all ICD codes associated with medical conditions present from birth as excluded ICDs in the healthcare insurance policy. As another example, a healthcare guarantor may identify all ICD codes associated with maternity services as limited ICDs in healthcare insurance policy.

When the adherent or a healthcare provider submits a medical insurance claim (or insurance eligibility request, etc.), they are required to select an ICD code that identifies the healthcare services that the adherent requested or received from the healthcare provider. The healthcare guarantor compares the ICD codes included in the claim (or in the eligibility request message, etc.) to the allowed, limited, or excluded ICD codes in the adherent's healthcare insurance policy to determine whether to approve, partially approve or deny the requested/received service. The healthcare guarantor may also use these ICD codes to determine the adherent's out-of-pocket expenses.

Each country, territory or system may use a different disease or ICD coding system or version to identify healthcare services. The healthcare guarantor system cannot properly determine whether to approve, partially approve or deny the requested/received service when the ICD code system/version used in the eligibility request/claim is different from the ICD code system/version used to identify the allowed/limited/excluded ICDs in the healthcare insurance policy. In such cases, conventional solutions must use manual processing or a manual mapping between the different ICD codes.

Automating the mapping is also challenging when using conventional solutions because the mapping between the different codes becomes increasingly complex (e.g., the possible permutations becomes factorial) as the number of different systems/versions increases. For example, supporting two versions (e.g., ICD9CM and ICD10-CM) requires two mappings (e.g., ICD9CM to ICD10-CM and ICD10-CM to ICD9CM). Supporting three versions (e.g., ICD9CM, ICD10-CM and ICD10-AM) requires six (6) different permutations of the mappings. Four versions require the use of twelve (12) different mappings.

To overcome these and other limitations of conventional solutions, the cross border system may be configured to implement and use the disease related condition (DRC) codes to classify each ICD system/version. This is a one-time exercise per ICD system/version supported, and allow the cross border system to support hundreds or thousands ICD system/version without increasing the processing complexity of processing claims or determining whether to approve, partially approve or deny the requested/received service.

As an example, if an eligibility request is coded using ICD10-AM, the system may automatically determine whether the request should be rejected if its ICD is part of the general exclusion (GE) condition of the insurance policy even if the policy was issued in a territory that uses ICD10-CM (or some other system). This is because the system does not have to map ICD10-AM to ICD10-CM. Rather, the system will classify the eligibility based on the DRC code that ICD code is under, and then checks to determine whether the policy has an exclusion set for the DRC code.

The system can automatically validate that a claim does not contradict any of the medical conditions excluded/specified in the policy and thus should be paid unless other rules reject it. When a medical policy is issued on the system, the details of the medical conditions excluded and or conditions that have financial limits are configured on the system to facilitate eligibility automation. When selecting excluded or limited conditions, to configure the policy on the Insurance system, users typically select a list of disease codes (ICD).

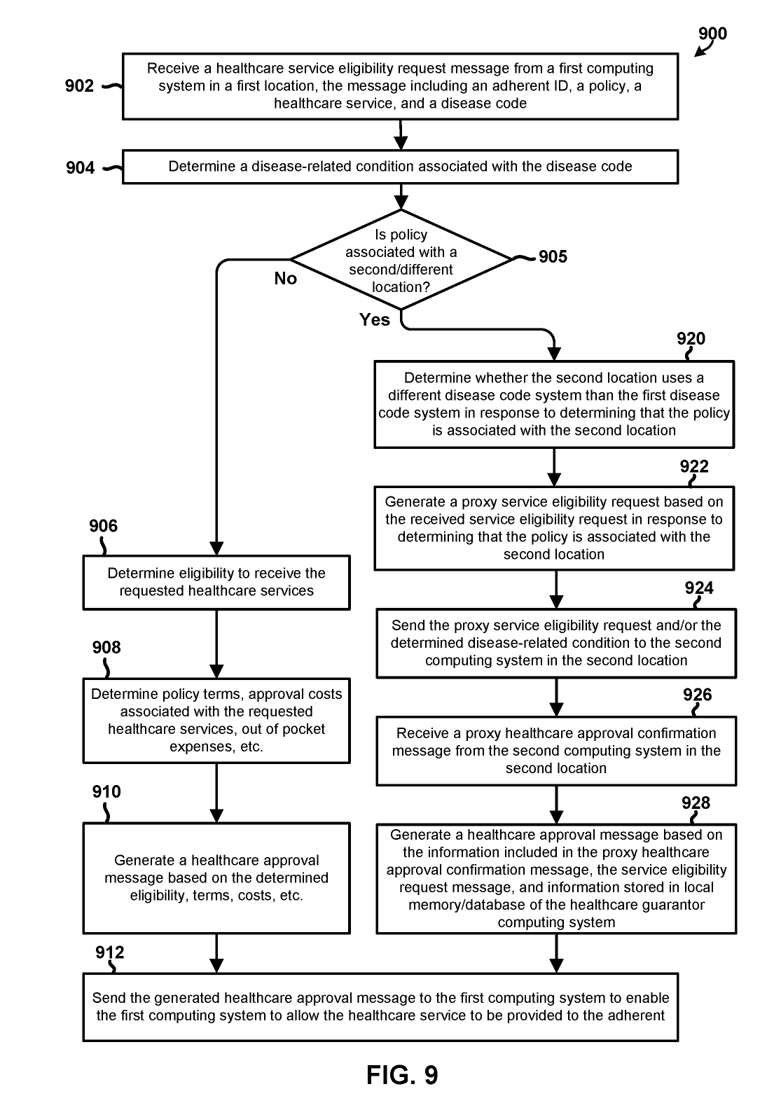

FIG. 9 illustrates a method 900 for approving healthcare services requested by an adherent in accordance with an embodiment. Method 900 may be performed via one or more processors in a healthcare guarantor computing system, which may be included as part of a cross-border system.

In block 902, the processor may receive a healthcare service eligibility request message from a first computing system (e.g., healthcare provider computing system, etc.) in a first location (e.g., in Mexico, etc.). The healthcare service eligibility request message may include an adherent ID, a proxy guarantor, a policy, a healthcare service, and a disease code of a first disease code system.

In block 904, the processor may determine a disease-related condition (DRC) associated with the disease code included in the received healthcare service eligibility request message. The DRC may classify each ICD system/version used by the many different locations/countries without the use of mappings, which allows the cross border system to support hundreds or thousands ICD system/version without increasing the processing complexity of processing claims or determining whether to approve, partially approve or deny the requested/received service.

In determination block 905, the processor may determine whether the policy included in the received healthcare service eligibility request message is associated with a second/different location (e.g., United States, etc.). For example, the processor may determine that the adherent is not a local member, that the adherent is registered with a system in a different country, that the policy was not registered in the first location (e.g., in Mexico, etc.), that the policy was registered in the second location (e.g., United States, etc.), etc.

In response to determining that the policy included in the received healthcare service eligibility request message is not associated with a second location (i.e., determination block 905=“No”), the processor may determine the eligibility of the adherent to receive the requested healthcare services in block 906. In block 908, the processor may determine policy terms, approval costs associated with the requested healthcare services, out of pocket expenses, and/or perform any or all of the operations discussed above with reference to blocks 708-720 in FIG. 7. In block 910, the processor may generate a healthcare approval message based on the determined eligibility, terms, costs, etc. In block 912, the processor may send the generated healthcare approval message to the first computing system (e.g., the healthcare provider computing system used by the healthcare provider in Mexico, etc.) to enable the first computing system to allow the requested healthcare services to be provided to the adherent.

In response to determining that the policy included in the received healthcare service eligibility request message is associated with a second location (i.e., determination block 905=“Yes”), the processor may determine whether the second location uses a different disease code system than the first disease code system in block 920. Alternatively or in addition, the processor may generate a proxy service eligibility request based on the received service eligibility request in block 922 in response to determining that the policy is associated with the second location. The proxy service eligibility request may replace an identifier of a healthcare provider associated with the first computing system with an identifier of a proxy provider or proxy provider ID. In block 924, the processor may send the proxy service eligibility request and/or the determined disease-related condition to the second computing system (e.g., a healthcare payer, a second healthcare guarantor computing system, etc.) that is associated with a second location (e.g., United States, etc.).

By replacing the identifier of a healthcare provider with an identifier of a proxy provider in block 922 and sending the message to the second computing system in block 924, the system allows the second computing system verify eligibility to received services and fulfil the policy without having access to a reference or information about the actual provider or the first computing system. In addition, including the identifier of the proxy provider in the proxy service eligibility request informs the second computing system that it does not have to compute costs or perform other similar operations. Including the identifier of the proxy provider in the proxy service eligibility request also informs the second computing system that it has to pay a provider associated with the first computing system, without requiring the second computing system to have access to details regarding that provider or computing system. These and other operations of method 900 improve the performance and functioning of computing systems that validate healthcare coverage (e.g., healthcare guarantor computing system, healthcare provider computing system, etc.) because they eliminate, hide or reduce complexities of interacting with a multitude of different healthcare provider systems from the actual healthcare guarantor system, reduce the operations costs associated with providing iPMI policies on a direct settlement basis, enable healthcare guarantors to provide more robust plans, assure healthcare providers that they'll be paid for their work, encourage patients to purchase and use iPMI policies, and allow patients to receive healthcare services from many different healthcare providers in many different countries.

Returning to FIG. 9, in block 926, the processor may receive a proxy healthcare approval confirmation message from the second computing system in response to sending the proxy service eligibility request to the second computing system in the second location.

In block 928, the processor may generate a healthcare approval message based on the information included in the proxy healthcare approval confirmation message, the service eligibility request message, and information stored in local memory/database of the healthcare guarantor computing system. That is, the healthcare approval message may be generated based on a combination of the information included in the proxy healthcare approval confirmation message received from the second computing system, the information included in the service eligibility request received from the first computing system, and information stored in a memory coupled to the healthcare guarantor computing system.

By generating a proxy service eligibility request based on the received service eligibility request in response to determining that the policy is associated with the second location, sending the proxy service eligibility request and the determined disease-related condition to a second computing system in the second location, receiving a proxy healthcare approval confirmation message from the second computing system, and using a combination of the information included in the proxy healthcare approval confirmation message received from the second computing system, the information included in the service eligibility request received from the first computing system, and information stored in a memory coupled to the healthcare guarantor computing system to generate the healthcare approval message, the various embodiments provide a technical solution to the technical problem of allowing disparate healthcare systems that are created and managed by different entities in different territories to cooperatively provide services to an adherent. As a result, the embodiments overcome the technical challenges present in conventional solutions to provide improved cross-border coverage services to an adherent without the manual, inefficient and time-consuming analysis, cumbersome processing or expensive intermediaries required using conventional solutions.

In block 912, the processor may send the generated healthcare approval message to the first computing system to enable the first computing system to allow the requested healthcare services to be provided to the adherent in the first country without the adherent paying out of pocket expenses or filing out addition forms, and while ensuring that the provider associated with the first computing system will be reimbursed for all or portions of the costs of the services provided to the adherent.

In some embodiments, method 900 may further include determining that received service eligibility request is for a proxy guarantor, and determining to forgo determining whether the policy is valid and whether the adherent is eligible to receive all or part of the healthcare service in response to determining that the received service eligibility request is for the proxy guarantor.

In some embodiments, the operations for generating the proxy service eligibility request may be performed in response to determining that the received service eligibility request is for the proxy guarantor.

In some embodiments, the processor may be configured to determine, based on information included in the received service eligibility request, that the request is for a proxy guarantor. The processor may determine to forgo using mappings in response to determining that the received service eligibility request is for the proxy guarantor.

In some embodiments, the processor may determine based on information included in the received service eligibility request that the request is for a proxy guarantor, and determine that the second computing system is a computing system within a plurality of available computing systems that is responsible for receiving requests for the proxy guarantor. In some embodiments, the operations of sending the proxy service eligibility request and the determined disease-related condition to the second computing system in the second location are performed in response that determining that the second computing system is the computing system responsible for receiving requests for the proxy guarantor.

In some embodiments, sending the proxy service eligibility request and the determined disease-related condition to the second computing system in the second location is accomplished by sending the proxy service eligibility request and the determined disease-related condition from a first healthcare guarantor computing system associated with a first healthcare guarantor in a first country (e.g., from SGS 719 illustrated in FIG. 7) to a different healthcare guarantor computing system associated with a different healthcare guarantor in a different country (e.g., to FGS 703 illustrated in FIG. 7) that uses a different disease code system than the first disease code system.

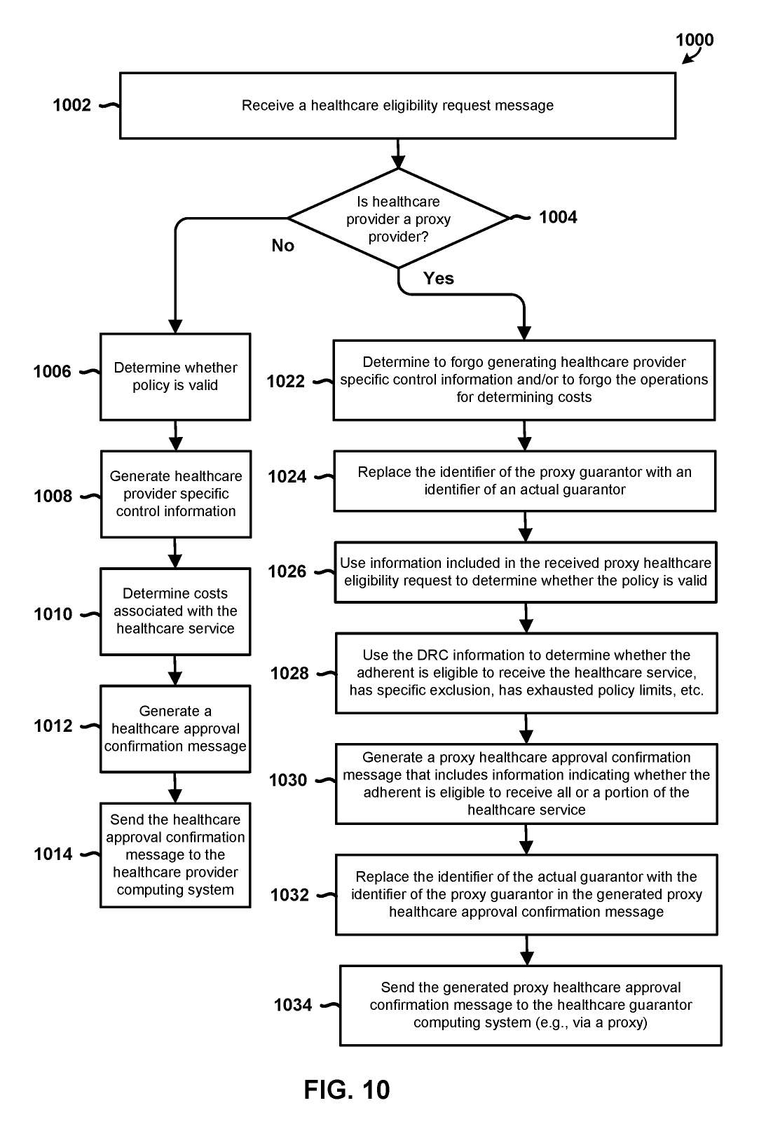

FIG. 10 illustrates a method 1000 for approving healthcare services requested by an adherent in accordance with another embodiment. Method 1000 may be performed via one or more processors in a healthcare guarantor computing system, which may be included as part of a cross-border system.

In block 1002, the processor may receive a healthcare eligibility request message. The healthcare eligibility request message may include various parameters, information fields, and values, including parameters/values/fields suitable for identifying the adherent, a proxy guarantor, a proxy provider (e.g., via a proxy provider ID, etc.), a policy, a healthcare service, and a disease code. In some embodiments, the processor may also receive disease-related condition (DRC) information in block 1002.

In determination block 1004, the processor may determine whether the healthcare provider is a proxy provider and/or whether the received healthcare eligibility request message is a proxy healthcare eligibility request message. For example, the processor may use the information (e.g., a proxy provider ID, etc.) included in the received healthcare eligibility request to determine that the healthcare provider is a proxy provider. The processor may also determine that the healthcare provider is a proxy provider in response to determining that it received DRC information along with the healthcare eligibility request message.

In response to determining that the healthcare provider is not a proxy provider (i.e., determination block 1004=“No”), the processor may determine whether policy is valid in block 1006, generate healthcare provider specific control information in block 1008, determine costs associated with the healthcare service in in block 1010, generate a healthcare approval confirmation message in block 1012, and send the healthcare approval confirmation message to the computing system associated with the healthcare provider in block 1014.

In response to determining that the healthcare provider is a proxy provider or that the received healthcare eligibility request message is a proxy healthcare eligibility request message (i.e., determination block 1004=“Yes”), in block 1022, the processor may determine to forgo generating healthcare provider specific control information and/or to forgo the operations for determining costs.

In block 1024, the processor may decode the proxy healthcare eligibility request message, identify the actual guarantor, and replace the identifier of the proxy guarantor with an identifier of an actual guarantor.

In block 1026, the processor may use the information included in the received proxy healthcare eligibility request to determine whether the policy is valid.

In block 1028, the processor may use the received DRC information to determine whether the adherent is eligible to receive the healthcare service, has general or specific exclusions, has exhausted policy limits, etc. In the some embodiments, the processor may perform the operations in block 1028 in response to determining that the policy is valid.

In block 1030, the processor may generate a proxy healthcare approval confirmation message that includes information indicating whether the adherent is eligible to receive all or a portion of the healthcare service.

In block 1032, the processor may replace the identifier of the actual guarantor with the identifier of the proxy guarantor in the generated proxy healthcare approval confirmation message.

In block 1034, the processor may send the generated proxy healthcare approval confirmation message to the healthcare guarantor computing system (e.g., via a proxy) that is associated with the country in which the adherent requested to receive healthcare services.

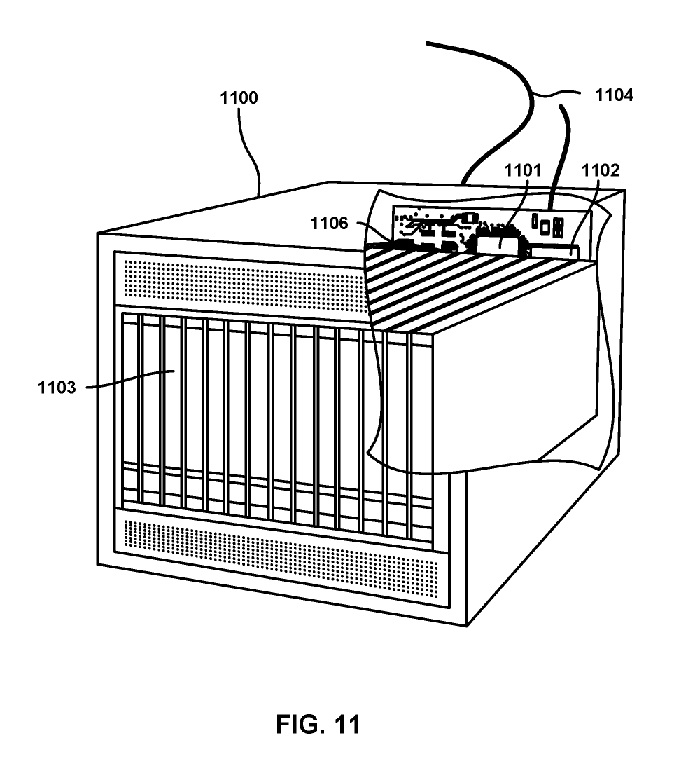

Various embodiments (including, but not limited to, embodiments discussed above with reference to FIGS. 7-10) may be implemented on any of a variety of commercially available computing devices, such as the server computing device 1100 illustrated in FIG. 11. Such a server device 1100 may include a processor 1101 coupled to volatile memory 1102 and a large capacity nonvolatile memory, such as a disk drive 1103. The server device 1100 may also include a floppy disc drive, USB, compact disc (CD) or DVD disc drive coupled to the processor 1101. The server device 1100 may also include network access ports 1104 coupled to the processor 1101 for establishing data connections with a network connection circuit 1106 and a communication network (e.g., IP network) coupled to other communication system network elements.

The processors discussed in this application may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processors themselves. Additionally, as used herein, any reference to a memory may be a reference to a memory storage and the terms may be used interchangeable.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of one method may be substituted for or combined with one or more operations of the other methods.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for approving healthcare services requested by an adherent, comprising:
receiving, via a processor in a healthcare guarantor computing system, a service eligibility request from a first computing system in a first location, wherein the service eligibility request identifies:
the adherent;
a proxy guarantor;
a policy;
a healthcare service; and
a disease code of a first disease code system;
determining, via the processor in the healthcare guarantor computing system, a disease-related condition associated with the disease code;
determining, via the processor in the healthcare guarantor computing system, whether the policy is associated with a second location;
determining, via the processor in the healthcare guarantor computing system, whether the second location uses a different disease code system than the first disease code system in response to determining that the policy is associated with the second location;
generating, via the processor in the healthcare guarantor computing system, a proxy service eligibility request based on the received service eligibility request in response to determining that the policy is associated with the second location, wherein the proxy service eligibility request replaces an identifier of a healthcare provider with an identifier of a proxy provider;
sending, via the processor in the healthcare guarantor computing system, the proxy service eligibility request and the determined disease-related condition to a second computing system in the second location;
receiving, via the processor in the healthcare guarantor computing system, a proxy healthcare approval confirmation message in response to sending the proxy service eligibility request to the second computing system in the second location;
generating, via the processor in the healthcare guarantor computing system, a healthcare approval message based on a combination of:
information included in the proxy healthcare approval confirmation message received from the second computing system;
information included in the service eligibility request received from the first computing system; and
information stored in a memory coupled to the healthcare guarantor computing system; and
sending the generated healthcare approval message to the first computing system to enable the first computing system to provide the healthcare service to the adherent.

2. The method of claim 1, further comprising:
receiving, via a processor in the second computing system, the proxy service eligibility request and the determined disease-related condition from the healthcare guarantor computing system;
replacing the identifier of a proxy guarantor with an identifier of an actual guarantor;
using information included in the received proxy service eligibility request to determine whether the policy is valid;
using the received disease-related condition information to determine whether the adherent is eligible to receive the healthcare service in response to determining that the policy is valid;
generating the proxy healthcare approval confirmation message to include information indicating whether the adherent is eligible to receive all or part of the healthcare service, wherein the generated proxy healthcare approval confirmation message replaces the identifier of the actual guarantor with the identifier of the proxy guarantor; and
sending the generated proxy healthcare approval confirmation message to the healthcare guarantor computing system.

3. The method of claim 2, further comprising:
determining, via the processor in the second computing system, based on information included in the received proxy service eligibility request that the healthcare provider is a proxy provider;
generating healthcare provider specific control information and determining costs associated with the healthcare service in response to determining that the healthcare provider is not a proxy provider; and
determining to forgo generating healthcare provider specific control information and determining the costs associated with the healthcare service in response to determining that the healthcare provider is a proxy provider.

4. The method of claim 1, further comprising:
determining, via the processor in the healthcare guarantor computing system, based on information included in the received service eligibility request is for a proxy guarantor; and
determining to forgo determining whether the policy is valid and whether the adherent is eligible to receive all or part of the healthcare service in response to determining that the received service eligibility request is for the proxy guarantor.

5. The method of claim 1, further comprising:
determining, via the processor in the healthcare guarantor computing system, based on information included in the received service eligibility request is for a proxy guarantor,
wherein the operation of generating the proxy service eligibility request is performed in response to determining that the received service eligibility request is for the proxy guarantor.

6. The method of claim 1, further comprising:
determining, via the processor in the healthcare guarantor computing system, based on information included in the received service eligibility request is for a proxy guarantor; and
determining to forgo using mappings in response to determining that the received service eligibility request is for the proxy guarantor.

7. The method of claim 1, further comprising:
determining, via the processor in the healthcare guarantor computing system, based on information included in the received service eligibility request is for a proxy guarantor;
determining that the second computing system is a computing system within a plurality of available computing systems that is responsible for receiving requests for the proxy guarantor;
wherein the operation of sending the proxy service eligibility request and the determined disease-related condition to the second computing system in the second location is performed in response that determining that the second computing system is the computing system responsible for receiving requests for the proxy guarantor.

8. The method of claim 1, wherein sending the proxy service eligibility request and the determined disease-related condition to the second computing system in the second location comprises:
sending the proxy service eligibility request and the determined disease-related condition from a first healthcare guarantor computing system associated with a first healthcare guarantor in a first country to a different healthcare guarantor computing system associated with a different healthcare guarantor in a different country that uses a different disease code system than the first disease code system.

9. A computing device, comprising:
a processor configured with processor-executable software instructions to perform operations comprising:
receiving a service eligibility request from a first computing system in a first location, wherein the service eligibility request identifies:
an adherent;
a proxy guarantor;
a policy;
a healthcare service; and
a disease code of a first disease code system;
determining a disease-related condition associated with the disease code;
determining whether the policy is associated with a second location;
determining whether the second location uses a different disease code system than the first disease code system in response to determining that the policy is associated with the second location;
generating a proxy service eligibility request based on the received service eligibility request in response to determining that the policy is associated with the second location, wherein the proxy service eligibility request replaces an identifier of a healthcare provider with an identifier of a proxy provider;
sending the proxy service eligibility request and the determined disease-related condition to a second computing system in the second location;
receiving a proxy healthcare approval confirmation message in response to sending the proxy service eligibility request to the second computing system in the second location;
generating a healthcare approval message based on a combination of:
information included in the proxy healthcare approval confirmation message received from the second computing system;
information included in the service eligibility request received from the first computing system; and
information stored in memory; and
sending the generated healthcare approval message to the first computing system to enable the first computing system to provide the healthcare service to the adherent.

10. The computing device of claim 9, wherein the processor is configured with processor-executable software instructions to perform operations further comprising:
determining based on information included in the received service eligibility request is for a proxy guarantor; and
determining to forgo determining whether the policy is valid and whether the adherent is eligible to receive all or part of the healthcare service in response to determining that the received service eligibility request is for the proxy guarantor.

11. The computing device of claim 9, wherein the processor is configured with processor-executable software instructions to perform operations further comprising:
determining based on information included in the received service eligibility request is for a proxy guarantor,
wherein the operation of generating the proxy service eligibility request is performed in response to determining that the received service eligibility request is for the proxy guarantor.

12. The computing device of claim 9, wherein the processor is configured with processor-executable software instructions to perform operations further comprising:
determining based on information included in the received service eligibility request is for a proxy guarantor; and
determining to forgo using mappings in response to determining that the received service eligibility request is for the proxy guarantor.

13. The computing device of claim 9, wherein the processor is configured with processor-executable software instructions to perform operations further comprising:
determining based on information included in the received service eligibility request is for a proxy guarantor;
determining that the second computing system is a computing system within a plurality of available computing systems that is responsible for receiving requests for the proxy guarantor;
wherein the operation of sending the proxy service eligibility request and the determined disease-related condition to the second computing system in the second location is performed in response that determining that the second computing system is the computing system responsible for receiving requests for the proxy guarantor.

14. The computing device of claim 9, wherein the processor is configured with processor-executable software instructions to perform operations such that sending the proxy service eligibility request and the determined disease-related condition to the second computing system in the second location comprises:
sending the proxy service eligibility request and the determined disease-related condition from a first healthcare guarantor computing system associated with a first healthcare guarantor in a first country to a different healthcare guarantor computing system associated with a different healthcare guarantor in a different country that uses a different disease code system than the first disease code system.

15. A non-transitory computer readable storage medium having stored thereon processor-executable software instructions configured to cause a processor in a computing device to perform operations comprising
receiving a service eligibility request from a first computing system in a first location, wherein the service eligibility request identifies:
an adherent;
a proxy guarantor;
a policy;
a healthcare service; and
a disease code of a first disease code system;
determining a disease-related condition associated with the disease code;
determining whether the policy is associated with a second location;
determining whether the second location uses a different disease code system than the first disease code system in response to determining that the policy is associated with the second location;
generating a proxy service eligibility request based on the received service eligibility request in response to determining that the policy is associated with the second location, wherein the proxy service eligibility request replaces an identifier of a healthcare provider with an identifier of a proxy provider;
sending the proxy service eligibility request and the determined disease-related condition to a second computing system in the second location;
receiving a proxy healthcare approval confirmation message in response to sending the proxy service eligibility request to the second computing system in the second location;
generating a healthcare approval message based on a combination of:
information included in the proxy healthcare approval confirmation message received from the second computing system;
information included in the service eligibility request received from the first computing system; and
information stored in a memory coupled to the computing device; and
sending the generated healthcare approval message to the first computing system to enable the first computing system to provide the healthcare service to the adherent.

16. The non-transitory computer readable storage medium of claim 15, wherein the stored processor-executable instructions are configured to cause a processor to perform operations further comprising:
determining based on information included in the received service eligibility request is for a proxy guarantor; and
determining to forgo determining whether the policy is valid and whether the adherent is eligible to receive all or part of the healthcare service in response to determining that the received service eligibility request is for the proxy guarantor.

17. The non-transitory computer readable storage medium of claim 15, wherein the stored processor-executable instructions are configured to cause a processor to perform operations further comprising:
determining based on information included in the received service eligibility request is for a proxy guarantor,
wherein the stored processor-executable instructions are configured to cause a processor to perform operations such that the operation of generating the proxy service eligibility request is performed in response to determining that the received service eligibility request is for the proxy guarantor.

18. The non-transitory computer readable storage medium of claim 15, wherein the stored processor-executable instructions are configured to cause a processor to perform operations further comprising:
determining based on information included in the received service eligibility request is for a proxy guarantor; and
determining to forgo using mappings in response to determining that the received service eligibility request is for the proxy guarantor.

19. The non-transitory computer readable storage medium of claim 15, wherein the stored processor-executable instructions are configured to cause a processor to perform operations further comprising:
determining based on information included in the received service eligibility request is for a proxy guarantor;
determining that the second computing system is a computing system within a plurality of available computing systems that is responsible for receiving requests for the proxy guarantor;
wherein the stored processor-executable instructions are configured to cause a processor to perform operations such that the operation of sending the proxy service eligibility request and the determined disease-related condition to the second computing system in the second location is performed in response that determining that the second computing system is the computing system responsible for receiving requests for the proxy guarantor.

20. The non-transitory computer readable storage medium of claim 15, wherein the stored processor-executable instructions are configured to cause a processor to perform operations such that sending the proxy service eligibility request and the determined disease-related condition to the second computing system in the second location comprises:
sending the proxy service eligibility request and the determined disease-related condition from a first healthcare guarantor computing system associated with a first healthcare guarantor in a first country to a different healthcare guarantor computing system associated with a different healthcare guarantor in a different country that uses a different disease code system than the first disease code system.
